(19) United States
(12) Patent Application Publication
(10) Pub. No.: US 2009/0164034 A1
(43) Pub. Date: Jun. 25, 2009

(54) WEB-BASED PERFORMANCE COLLABORATIONS BASED ON MULTIMEDIA-CONTENT SHARING

(75) Inventors: Kevin Cohen, Van Nuys, CA (US); Tal Pink, Van Nuys, CA (US); Ryo Fujita, Van Nuys, CA (US)

Correspondence Address: PERKINS COIE LLP, P.O. BOX 1208, SEATTLE, WA, 98111-1208, US

(73) Assignee: DopeTracks, LLC, Van Nuys, CA (US)

(21) Appl. No.: 12/339,739

(22) Filed: Dec. 19, 2008

Related U.S. Application Data
(60) Provisional application No. 61/015,136, filed on Dec. 19, 2007.
(60) Provisional application No. 61/015,132, filed on Dec. 19, 2007.

(51) Int. Cl. G06F 17/00

(52) U.S. Cl. 700/94

(57) ABSTRACT

Systems and methods for web-based performance collaborations based on multimedia-content sharing are disclosed. In one aspect of the present disclosure, an audio mix request with a first audio track representing a beat is received. One embodiment includes, recording a second audio track provided by the recording user while simultaneously performing aural playback of the beat represented by the first audio track to the recording user during a recording session, providing aural playback of a preview of mixing the first audio track and the second audio track after the recording session has ended, and generating a mixed track from the first audio track and the second audio track.

### CLAIM OF PRIORITY

This application claims priority to U.S. Provisional Patent Application No. 61/015,132 entitled “WEB-BASED MUSICAL COLLABORATIONS BASED ON USER AUDIO-CONTENT SHARING”, which was filed on Dec. 19, 2007 the contents of which are expressly incorporated by reference herein.

This application claims priority to U.S. Provisional Patent Application No. 61/015,136 entitled “ONE-CLICK SOUND RECORDING AND SHARING”, which was filed on Dec. 19, 2007 the contents of which are expressly incorporated by reference herein.

### BACKGROUND

Rising young artists in the music industry have limited resources to promote their work to the public to gain traction. In particular, since most young artists do not yet have an identified set of audience, definitive market value on the promotional efforts is also difficult to capture placing an uncertainty on the overall value of public relations and promotional efforts for works of rising young artists.

Talent seeking of rising stars is also particularly difficult since these potential artists are often times mixing and recording from their home studios. Although established musicians and producers typically have specified needs for music talent, the task of identifying a rising artist with suitable skills, style, and/or talent is a near impossible task.

Development of alliance with another artist through partnership may also be difficult for rising young stars. For example, artists may have insufficient resources to seek industry partners, such as, a producer, a collaborator, a professional recording studio, a band, a singer, a rapper, a guitarist, and/or a pianist, etc.

### BRIEF DESCRIPTION OF THE DRAWINGS

FIG. 1 illustrates a block diagram of a plurality of client devices coupled to one another and a host server that facilitates web-based performance collaborations, multimedia-content sharing, exchange, and competition, according to one embodiment.

FIG. 2 depicts a block diagram illustrating a system of a host server to facilitate web-based performance collaborations, multimedia-content sharing, exchange, and competition between a plurality of users, the system includes a host server coupled to a user database, and/or a content database, according to one embodiment.

FIG. 3A depicts a block diagram illustrating a user database that stores user profile information and user content, according to one embodiment.

FIG. 3B depicts a block diagram illustrating a content database that stores audio content including beats and tracks, according to one embodiment.

FIG. 4A illustrates an example user interface of a listing of recently added tracks, according to one embodiment.

FIG. 4B illustrates an example user interface of a listing of recently added beats, according to one embodiment.

FIG. 5A illustrates an example user interface having an audio player/recorder widget (or multimedia player/recorder widget) for playing a track, according to one embodiment.

FIG. 5B illustrates an example user interface having the audio player/recorder widget (or multimedia player/recorder widget) and a graphical user interface widget (“widget”) to facilitate multimedia content sharing, collaboration, and competition among multiple platforms, according to one embodiment.

FIG. 5C-E illustrate further examples of the graphical user interface widget, according to one embodiment.

FIG. 5F illustrates an example user interface of an email message containing a link to an instance of an audio player/recorder widget (or multimedia player/recorder widget), according to one embodiment.

FIG. 5G illustrates an example user interface of the instance of the audio or multimedia player/recorder widget (or multimedia player/recorder widget) linked from the email message, according to one embodiment.

FIG. 6A illustrates example user interfaces of the audio player/recorder widget (or multimedia player/recorder widget) for recording over a beat, according to one embodiment.

FIG. 6B illustrates example user interfaces of a beat browser and a lyrics text box, according to one embodiment.

FIG. 6C illustrates an example user interface for uploading a beat, according to one embodiment.

FIG. 7 depicts a flow diagram illustrating an example process of recording an audio track or video content over a network, according to one embodiment.

FIG. 8A depicts a flow diagram illustrating an example process of generating a mixed audio track, according to one embodiment.

FIG. 8B depicts a flow diagram illustrating an example process of sharing a mixed audio track or performance art piece with other users, according to one embodiment.

FIG. 9A depicts a flow diagram illustrating an example process of recording multimedia content (audio content or video content) over a network via a click of a pointing device, according to one embodiment.

FIG. 9B depicts a flow diagram illustrating an example list of user interface buttons that can be generated to receive user selection, according to one embodiment.

FIG. 10A depicts a flow diagram illustrating an example process of providing a user interface having listings of mixed audio tracks and beats, according to one embodiment.

FIG. 10B depicts a flow diagram illustrating an example process of facilitating challenges between users, according to one embodiment.

FIG. 11 depicts a flow diagram illustrating an example process of web-based musical collaboration and audio mixing, according to one embodiment.

FIG. 12 depicts a flow diagram illustrating an example process of facilitating audio-based user content sharing and competition through a user interface, according to one embodiment.

FIG. 13 depicts a flow diagram illustrating an example process of facilitating multimedia content sharing, collaboration, and competition among multiple platforms using a graphical user interface widget, according to one embodiment.

FIG. 14 depicts a flow diagram illustrating an example process of facilitating web-based multi-media collaboration and multimedia content mixing using an online social network, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for web-based performance collaborations based on multimedia content sharing, for example, through an online interface.

In one aspect, the present disclosure relates to using an online social network for web-based musical collaborations and audio/multimedia content mixing.

In the online social network, an audio track can be provided by (e.g., recorded by) a recording user. A mixed track can be generated from mixing the audio track with another audio track that is provided by the recording user or another user also through the online social network. The audio track may be audibly generated by (e.g., sang by) the recording user and the audio track typically includes lyrics and another audio track includes a beat. The mixed track may be a rap song or songs of other genres.

In one aspect, the present disclosure relates to recording an audio track or video content over a network, in some instances, in real-time or in near real-time.

Audio tracks and video content can be produced by a user in the vicinity of an audio input device (e.g., microphone) or imaging device (e.g., camera, video recorder, web-cam) that is coupled to a computing device connected to a network. The video content can be uploaded or recorded. The video can be recorded using an imaging device in concurrence with or separate from an audio recording process. The video can be of a user generating the audio production or other types of theatrical performances of the user.

The audio track can be instrumental, electronica, vocal, rap, lyrical, chorus, acapella, etc. When the user is ready to record a track, the user can, by the click of a button (e.g., the ‘record button’) on the user interface, trigger a countdown to when the recording session will begin. The recording session may occur live over the network once the countdown commences. The user can begin the audio production process (e.g., sing, rap, talk, play an instrument, play music, compose, direct a band, DJ, and/or otherwise generating any form of audio content) in the vicinity of a microphone device coupled to the computing device. The user generated and/or provided audio content can then be recorded over the network, for example, in or near real-time.

Once the user has completed the recording process, a preview of the recorded track can be aurally played over the network back to the recording user and the video can be visibly played over the network to the user. Typically, the recorded content is stored in the buffer (e.g., memory buffer) after recording when being played for preview. The user can adjust the volume level of the recorded content based on the preview. If and when the recorded audio track or recorded video is satisfactory to the user, the track can be permanently saved. If the user chooses to discard the recorded content, the recorded content may be deleted from memory. In some instances, the user chooses to re-record the same content until satisfactory results are obtained.

When a recorded audio track or video content is permanently saved upon user request, the user can determine whether the track is accessible by other users. The user can set the privacy attribute associated with the recorded track and/or video content. For example, the recording user can make the recorded content publicly accessible (e.g., can be aurally played by other users), accessible to a select group of people, or private (e.g., is only visible to the recording user and/or can only be played by the recording user).

In some instances, the recorded track includes a beat (e.g., a rhythm). When the recording user of the audio track comprising beat has requested to save the recorded audio track, the beat can, in some instances, be made available to other users for mixing with other tracks and/or for use in audio productions or other multimedia productions. For example, other users can sing (e.g., rap) over the beat provided by the recording user of the beat. In addition, the length of time over which the track of the beat can be mixed can be pre-configured by the recording user of the track or the user that uploaded the track (e.g., track owner). For example, the owner of the track may allow other users to record over their track for a predetermined amount of time (e.g., a few seconds, a few minutes) or the full duration of the track.

In one aspect, the present disclosure relates to providing a mechanism for users to access audio productions or performances art pieces of others, and, in some instances, using the productions of others to generate collaborative content via the web-portal hosting the service site.

Users can record their own audio or video productions over another user's production (e.g., a beat). For example, users can browse listings of audio tracks or videos on the website provided by other users. The audio tracks may be mixed tracks of lyrics and rhythms (e.g., beats). A mixed track may be the collaborative result of multiple users of the web-based service. The users need not be physically proximal to one another to participate in a musical collaboration session. For example, a mixed track can be a product of a user providing a rhythm (e.g., a beat) and a vocal production (e.g., sing, solo, duet, whistle, rap, melody, etc.) of another user. The mixed track can also be a product of a rhythm and vocal production of the same user. Similarly, a performance art piece can be a product of a combination of audio content and video content provided by users that may be in physically disparate locations.

In most instances, a collaborative recording session can be requested and performed on demand. Since audio tracks and video content provided by users are stored on a server, the physical presence of each participant of the collaborative recording session is not necessary. The requested track for a recording session can be provided on-demand. For example, a user can select to sing or record a video over a track (e.g., rhythm, beat, melody) listed on the website. The user may, in some instances, preview a portion of the track or video by performing playback using an audio player/recorder widget in the user interface.

A recording session of audio, video, or a combination thereof, can also be initiated via the user interface by clicking a button on the audio player/recorder widget, for example. Before the recording session begins, typically playback of an audio track or video is stopped if playback is currently occurring. Once playback is paused/stopped, the user is provided with a countdown indicator to the initiation of the recording session. At the initiation of the recording session, the audio track or video content to which the recording user is recording over is played. No track is played during the recording session, in the situation when the user is not recording over another track or other multimedia content. When the recording session has ended, for example, by user request, the recording user has the option of previewing the recorded content. If the user recorded over another piece of multimedia content, the user can listen to or view the results of the multimedia mixing.

The recording (e.g., mixed audio track, acappela track, video content) can be saved upon user request, for example, when the user determines that the recording is satisfactory. In most instances, the recording user can optionally make the recording or the performance art piece generated from the recording accessible to other users. For example, other users can listen to the recorded track or view the video content/performance art piece via the web interface and provide comments and/or ratings.

In one aspect, the present disclosure relates to providing a mechanism for users to challenge mixed audio tracks (e.g., tracks mixed with a beat and a vocal production) in the web-portal.

The user (or challenger) can record a challenger track to challenge any mixed audio track. The challenger track is generated using the same beat as the mixed audio track. For example, the mixed audio track may be a rap song mixed from a rap beat and lyrics. Any number of challengers can initiate a challenge to any given mixed audio track. The challenger tracks that are stored can subsequently be stored and indicated as such in the user interface. Users or visitors of the web-portal can then rate the challenger tracks relative to the mixed audio track.

In one aspect, the present disclosure relates to facilitating audio-based user content sharing, collaboration, and competition among multiple platforms using a graphical user interface widget.

The graphical user interface widget can be used by a user in the source (host) platform to migrate an instance of an audio player/recorder widget to a different platform that is external to the host platform. For example, the instance of the audio player/recorded widget can be used on the external (target) platform for accessing the audio content on the host platform. In addition, audio content may be recorded using the instance of the widget on the external platform and made available for access on the host platform.

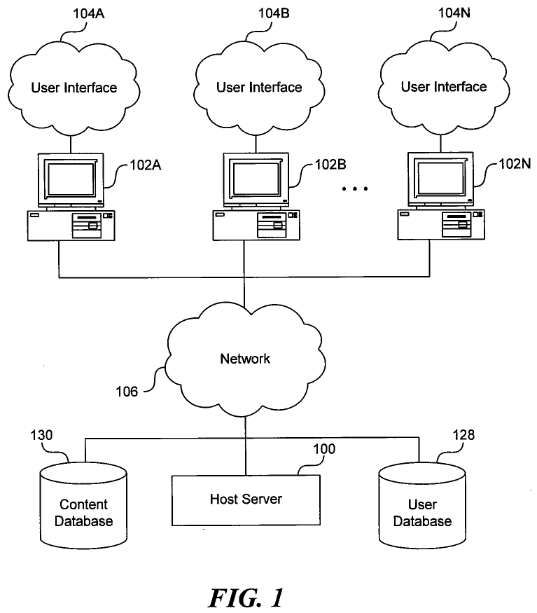

FIG. 1 illustrates a block diagram of a plurality of client devices 102A-N coupled to one another and a host server 100 that facilitates web-based performance collaborations, multimedia-content sharing, exchange, and competition, according to one embodiment.

The plurality of client devices 102A-N can be any system and/or device, and/or any combination of devices/systems that is able to establish a connection with another device, a server and/or other systems. The client devices 102A-N typically include display or other output functionalities to present data exchanged between the devices to a user. For example, the client devices and content providers can be, but are not limited to, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. In one embodiment, the client devices 102A-N are coupled to a network 106. In some embodiments, the client devices may be directly connected to one another.

The network 106, over which the client devices 102A-N may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices, host server, and may appear as one or more networks to the serviced systems and devices. In one embodiment, communications to and from the client devices 102A-N can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The client devices 102A-N can be coupled to the network (e.g., Internet) via a dial up connection, a digital subscriber loop (DSL, ADSL), cable modem, and/or other types of connection. Thus, the client devices 102A-N can communicate with remote servers (e.g., web server, host server, mail server, instant messaging server) that provide access to user interfaces of the World Wide Web via a web browser, for example.

The user database 128 and content database 130 can store software, descriptive data, images, system information, drivers, and/or any other data item utilized by parts of the host server 100 for operation. The databases 128 and 130 may also store user information and user content, such as, user profile information, subscription information, audio files, and/or data related to the user content (e.g., statistical data, file attributes, timing attributes, owner of the content, etc.). The user database 128 and content database 130 may be managed by a database management system (DBMS), for example but not limited to, Oracle, DB2, Microsoft Access, Microsoft SQL Server, PostgreSQL, MySQL, FileMaker, etc.

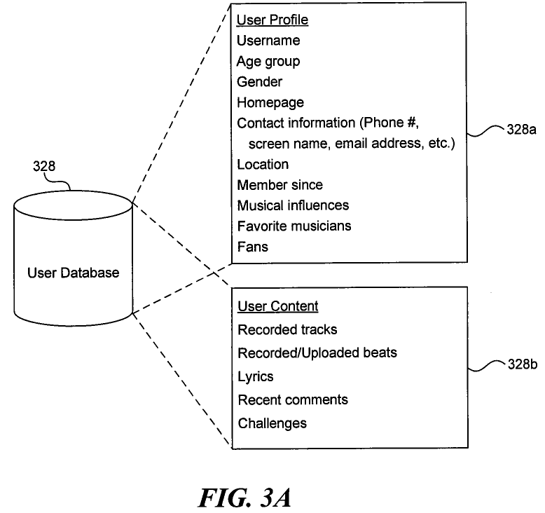

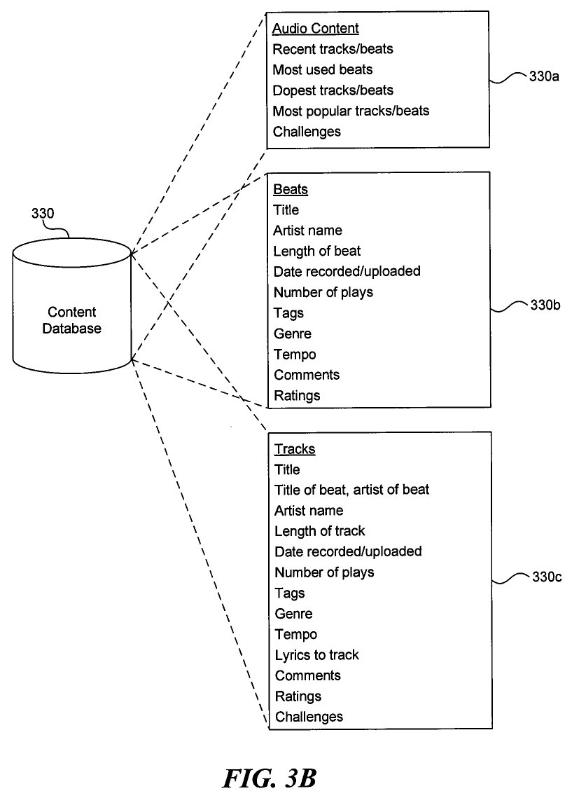

The databases 128 and 130 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package. An example set of data to be stored in the user database 128 and content database 130 is illustrated in FIG. 3A-3B.

The host server 100 is, in some embodiments, able to communicate with client devices 102A-N via the network 106. In addition, the host server 100 is able to retrieve data from the user database 128 and the content database 130. In some embodiments, the host server 100 is able to facilitate web-based performance collaborations, multimedia-content sharing, exchange, and competition over a network (e.g., the network 106) among various users of the client devices 102A-N. Performance collaborations are typically conducted using user generated and/or user provided audio or multimedia content. The host server 100 can store the user multimedia content to be provided to other users, for example, for on-demand audio and/or video playback/recording. For example, users can listen to audio content or view video content shared by other users. Users can also, in some embodiments, record audio tracks over tracks such as tracks comprising beats provided by other users stored on the host system of the web-portal, or, in other words, create mixed tracks. These recording sessions can be conducted in real-time or near real-time as the user is generating the audio or video content, for example.

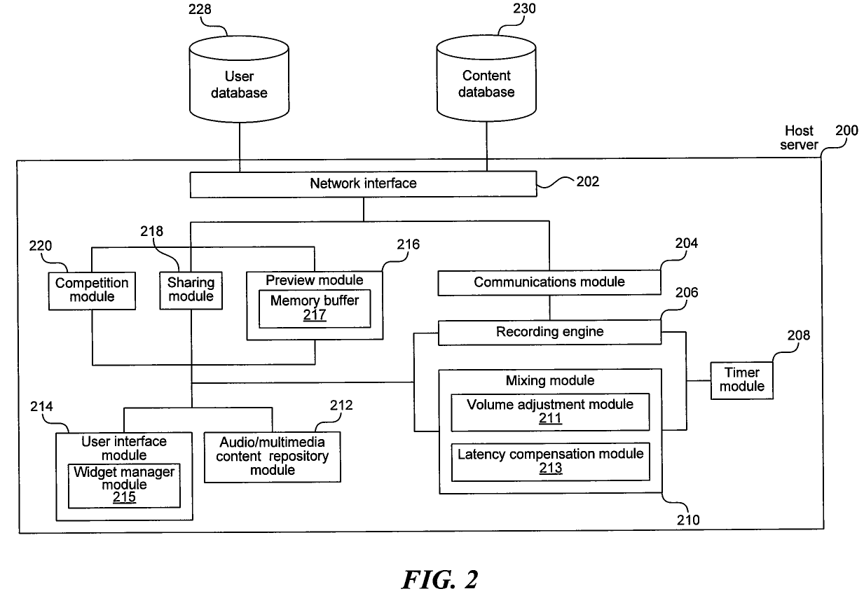

FIG. 2 depicts a block diagram illustrating a system of a host server 200 to facilitate web-based performance collaborations, multimedia-content sharing, exchange, and competition between a plurality of users, the system includes a host server 200 coupled to a user database 228, and/or a content database 230, according to one embodiment.

In the example of FIG. 2, the host server 200 includes a network interface 202, a firewall (not shown), a communications module 204, a recording engine 206, a timing module 208, a mixing module 210, an audio repository module 212, a user interface module 214, a preview module 216, a sharing module 218, and/or a competition module 220. In one embodiment, the mixing module 210 comprises a volume adjustment module 211 and a latency compensation module 213. The user interface module 214 can include a widget manager module 215. The preview module 216 can include a memory buffer 217. Additional or less modules may be included. The host server 200 may be communicatively coupled to the user database 228 and/or the content database 230 as illustrated in FIG. 2. In some embodiments, the user database 228 and/or the content database 230 are partially or wholly internal to the host server 200.

In the example of FIG. 2, the network controller 202 can be one or more networking devices that enable the host server 200 to mediate data in a network with an entity that is external to the host server, through any known and/or convenient communications protocol supported by the host and the external entity. The network controller 202 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure. In some embodiments, the functionalities of the network interface 202 and the firewall are partially or wholly combined and the functions of which can be implemented in any combination of software and/or hardware, in part or in whole.

In the example of FIG. 2, the host server 200 includes the communications module 204 or a combination of communications modules communicatively coupled to the network interface 202 to manage a one-way, two-way, and/or multi-way communication sessions over a plurality of communications protocols. In one embodiment, the communications module 204 receives data (e.g., audio data, textual data, audio files, video data, etc.), information, commands, requests (e.g., text, video, and/or audio-based), and/or text-based messages over a network. In one embodiment, the communications module 204 receives communications from a network (e.g., Internet, wired and/or wireless network) initiated via a web-interface.

Since the communications module 204 is typically compatible with receiving and/or interpreting data originating from various communication protocols, the communications module 204 is able to establish parallel and/or serial communication sessions with users of remote client devices for data exchange (e.g., user information and/or user content).

In addition, the communications module 204 can manage log-on requests received from one or more users browsing the web-based performance collaboration site. In one embodiment, the communications module 204 is able to receive and further manage/process receiving an audio mix request to mix an audio track with a beat from a recording user. In addition, the communications module 204 is further able to receive and process a request to generate a performance art piece from various pieces of multimedia content provided by various users through a web-portal to a social networking site. A connection is typically maintained with a user device until the user leaves the site. In one embodiment, when a user wishes to record a track, the communications module 204 prompts the user for permission to access peripheral devices (e.g., microphone, camera, web-cam, etc.) connected to the user device.

When the communications module 204 is able to access the microphone, the audio detected by the microphone can be recorded over a network. Similarly, when the communications module 204 is able to access the imaging device (e.g., camera, web-cam, video recorder), the audio detected by the microphone can be recorded over a network. The amount of time for which access rights are granted are in most instances configurable. For example, the communications module 204 may have access rights to peripheral devices on a session-by-session basis or for a predetermined duration of time, as specified by a user. The communications module 204, can include, one or more of, or any portion of the one or more of the above described functions, without deviating from the spirit of the novel art of the disclosure.

One embodiment of the present disclosure includes a recording engine 206. The recording engine 206 can be any combination of hardware components and/or software agents able to record multimedia (e.g., audio, text, image, and/or video) content for example, over a network connection (e.g., Internet). The audio-based content maybe user-generated (e.g., sang, spoken, rapped, etc.) content provided by the recording user. The recording engine 206, can, for example, establish a connection with a user device through the communications module 204. Upon detection of an audio input device or a video input device (e.g., microphone, camera, web-cam, video recorder, transducer, sensor) coupled to the user device, the recording engine 206 can record audio or video input (e.g., voice, speech, sound, dialogue, music, instruments music, rhythms, song, rap, melody, theatrical performance, movie, play, an act, a skit, etc.) detected by the audio and/or video input device.

In some instances, the recording engine 206 is able to receive user inputs and react in response to user inputs. For example, the recording engine 206 detects that a user has requested a recording session (e.g., requested via an audio/multimedia player/recorder widget in the user interface of a host platform (source platform) or an external platform (target platform)) and determines whether the user's input device (e.g., microphone or web-cam) is accessible. If not, the recording engine 206 can request the user for access to the input device.

Once the user requests to record an audio track or a video, the recording engine 206 presents an indication of the initiation of the recording session. For example, the recording engine 206 can countdown to the initiation and present an indicator (e.g., visual indicator and/or aural indicator) of the countdown status. When countdown ends, the recording engine 206 begins to record audio or video detected from the audio or video input device. In some embodiments, the recording session begins when the user generates the request without additional indication provided by the recording engine 206. During a recording session, the recording engine 206 can perform simultaneous aural playback of a beat to the recording user during a recording session when the recording user has requested to record over the beat.

The request for a recording session can be initiated from the host platform or a different platform that is external to and/or unaffiliated with the host platform. The recording engine 206 can receive and process either of such requests. For example, an instance of the audio/multimedia player/recorder widget can be migrated to an external platform (or target platform) through which users of that platform can access or otherwise interact with the instances of audio/multimedia player/recorder widget to playback tracks and/or to record tracks.

The recording engine 206 can also terminate the recording session. Recording session can be terminated after audio has been recorded for a predetermined amount of time. For example, the recording engine 206 is, in some embodiments, coupled to a timer module 208 to keep track of recording time, countdown time, and/or playing time, etc. The timer module 208 may be internal to the recording engine 206. In addition, the recording session can be terminated in response to receiving a user request (e.g., by the click of a button on the user interface) or in response to a terminating indication of the recording session. The termination indication may be, one or more of, duration of elapsed time and a user-generated termination request.

The timer module 208 can be any combination of hardware components and/or software agents able to determine relative and/or absolute time. The timer module 208, in some embodiments, tracks the time elapsed. In addition, the timer module 208, in some embodiments, externally couples to a time server (e.g., World Time Server, NTP time server, U.S. Time server, etc.) to keep track of time. The timer module 208 is, in some embodiments, accessible by the recording engine 206 and/or the mixing module 210 to track recording time and/or playback time. In some instances, elapsed time is usually displayed while mixing music from multiple tracks.

One embodiment of the present disclosure includes a preview module 216. The preview module 216 can be any combination of hardware components and/or software agents able to perform playback of multimedia content such as playback of recorded content and/or simultaneous playback of multiple pieces of multimedia content (e.g., audio, image, video, etc.). In some instances, the preview module 216 includes memory (e.g., volatile and/or non-volatile) and/or storage unit (e.g., magnetic disk drive, optical disk drive, etc.) for storing multimedia content (e.g., audio, video, image or the like). In one embodiment, the preview module 216 includes a memory buffer 217. Multimedia content stored in the preview module 216 may be stored temporarily (e.g., in the memory buffer 217) during preview and/or further until the user decides to save or discard the stored content. The stored content can include recorded or uploaded audio, image, and/or video content, for example.

The preview module 216 is also, in some embodiments, coupled to the audio/multimedia content repository module 212 to access multimedia content stored in the repository. The preview module 216 is, in some embodiments, able to receive, manage, and/or execute a request to preview a particular track. A preview typically occurs after a new recording or a new upload of an audio track or video content. After the preview, the preview module 216 can discard or save the file based on user request. In some embodiments, a preview occurs for saved audio content, for example, for content stored in the audio/multimedia repository module 212.

In one embodiment, the preview module 216 provides aural playback of a preview of mixing the first audio track and the second audio track after the recording session has ended. The preview module 216 enables a recording user to preview what a mix of a recorded track and a beat would sound like when mixed together by performing simultaneous aural playback of the first audio track (e.g., recorded track) and the second audio track (e.g., beat). Similarly, the preview module 216 could further enable a recording user to preview a mix of video content and an audio track. The preview would thus allow the recording user to decide to save the recorded content or to discard the recorded content and re-record. In addition, the preview allows the user to make any adjustments to the recorded content (e.g., color, volume, frequency, speed, etc.). For example, the preview of what a mixed track would sound like enables the recording user to request any adjustment in the recorded track and/or the beat when they are mixed together.

For example, the recording user can adjust the volume of the recorded track and/or the volume of the beat in generating the mixed track from the recorded track and the beat. In one embodiment, volume adjustments are performed automatically. The volumes of the recorded track and/or the volume of the beat may need adjustment prior to mixing due to the variance in the volume at which the tracks were recorded or uploaded. For example, the recorder's recording volume and the microphone may introduce variations in the volume of a recorded track.

In one embodiment, the preview of the mixed track or mixed multimedia content enables the recording user to request latency adjustment between the pieces of multimedia content to be mixed together. Since one or more of the tracks is typically recorded over a network, network delays could cause the recording of the track to be delayed in time. The amount of latency adjustment can be manually determined, system determined, or predetermined. The nature of the latency can be introduced from any number of sources including but not limited to, user delay, network delay, and/or device delay, etc.

One embodiment of the present disclosure includes a mixing module 210. The mixing module 210 can be any combination of hardware components and/or software agents able to combine multiple audio tracks and to generate a mixed track and to perform any additional processing procedures. For example, when a user elects to record a track over another track (e.g., such as a beat), the mixing module 210 generates a mixed track from the recorded track and the beat. The mixed track can be previewed by the user and subsequently stored, for example, in the audio repository module 212 or any other memory storage unit. Prior to mixing, the user can configure any settings that need to be performed in the process of mixing such as volume adjustments or latency adjustments between the tracks to be mixed.

In addition, the mixing module 210 can combine multiple pieces of multi-media content to generate a performance art piece that represents web-enabled collaborative effort. For example, the mixing module 210 can combine or otherwise mix various types of content provided by various users of the online service (e.g., online social network) to generate the performance art piece. The multiple pieces of multi-media content can include an audio track provided by a user through a network (Internet) connection to be combined with other multimedia content which may be provided by other users.

For example, the audio track may be mixed with a video or combined with an image for playback using the audio/multimedia player/recorder widget. The video or image may be recorded or uploaded by the same user that provided the audio track or a different user. This mixing allows performance art pieces comprising multimedia data to be generated based on a multi-user collaboration process. The performance art pieces can include, by way of example, but not limitation, a music video, a play, a skit, a performance video, a dance performance, and/or a movie, etc.

Additional mixing functions of the mixing module 210 can include but are not limited to, gain adjustment, pan adjustment, volume adjustment, mutes, solo controls, equalizer adjustments, compression, special effects, speed adjustment, latency compensation (adjustment), time delays, synchronization, filtering, noise removal/cancellation, and/or spectral analysis. Further, the mixing module 210 is able to perform image processing techniques and/or video processing techniques including but not limited to, geometric conversions, color adjustments, digital compositing, de-mosaicing, image editing, morphing, segmenting, video de-noising, deinterlacing, de-flicking, filtering, etc. The mixing module 210, can include, one or more of, or any portion of the one or more of the above described functions, without deviating from the spirit of the novel art of the disclosure.

One embodiment of the mixing module 210 further includes a volume adjustment module 211 and/or a latency compensation module 213. The volume adjustment module 211 can be any combination of hardware components and/or software agents able to adjust the absolute or relative volumes between the tracks or other multimedia content such as videos. The volumes of the tracks (e.g., a rhythm and a beat) and/or videos to be mixed by the mixing module 210 can be adjusted prior to mixing. The volumes can be adjusted responsive to a user request or automatically adjusted based on predetermined or default settings.

The latency compensation module 213 can be any combination of hardware components and/or software agents able to compensate for the latency in one or more tracks or other multimedia content (e.g., videos) that are to be mixed or combined to generate a mixed track or a performance art piece. For audio content, the latency can be compensated for by time delaying the first audio track by a predetermined amount of time when mixing with the second audio track. For example, the predetermined amount of time is within a range of 1-50 ms, 50-100 ms, or 100-500 ms. For mixing audio content and video content, the latency can be compensated for by time delaying one of the pieces depending on the amount of delay introduced during the recording process.

In one embodiment, the latency compensation module 213 computes the latency for a particular client used by the recording user for recording the audio track or video content based on network delay or other delays. For example, the latency can be computed by determining statistical attributes for various recordings and their associated delays. Latency can also be computed for a particular client device on a session-by-session basis, for example, by pinging the client device and tracking the delay.

The host server 200 in the example of FIG. 2, in accordance with one embodiment, further includes the audio/multimedia repository module 212. The audio/multimedia repository module 212 can be any combination of hardware modules and/or software agents able to store, playback, and/or read audio-based and other multimedia data and content, in a variety of formats, including, but not limited to, mp3, mp4, m4a, m4p, aac, wma, ra, wav, ogg, flac, aiff, raw, aw, DVD, CD, Blu-Ray, HD-DVD, DTS-CD, SACD, etc. The audio/multimedia repository module 212 can be, in some embodiments, accessible by the recording engine 206 and the mixing module 210. For example, audio content (e.g., pre-recordings, synthesized audio tracks, speech, voice, music, mixes, etc.) can be stored in the audio/multimedia repository module 212 after a track is recorded by the recording engine 206 or after a mixed audio track is generated by the mixing module 210. Video content can be stored in the audio/multimedia repository module 212 after a video is recorded by the recording engine 206 or after mixed multimedia content is generated by the mixing module 210.

Audio tracks and video content stored in the audio/multimedia repository module 212 typically include user content (e.g., user generated and/or user provided audio/video/image content). For example, audio tracks can include but are not limited to, rhythms, melodies, vocal expressions (e.g., voice, speech, dialogue, sing, rap, etc.), beats, music, instrumental sounds, synthetic audio content, and/or any other type of digital and/or analog representations of sound. In some embodiments, the audio/multimedia repository module 212 stores a standard voice greeting and/or instructions for users, for example, for users with visual disabilities. The audio/multimedia repository module 212 may further include digital signal processors (DSPs) that support generation of digital audio/video content modification and/or implementation of audio/video effects/mixing.

One embodiment of the present disclosure includes a user interface module 214. The user interface module 214 can be any combination of hardware components and/or software agents able to generate, modify, and/or adjust user interfaces and widgets suitable for receiving user input for querying, multimedia content recording, multimedia content exchange, multimedia content playback, collecting favorite tracks, tracking favorite artists, participate in a competition, and/or viewing/exchanging text-based messages to/from other users.

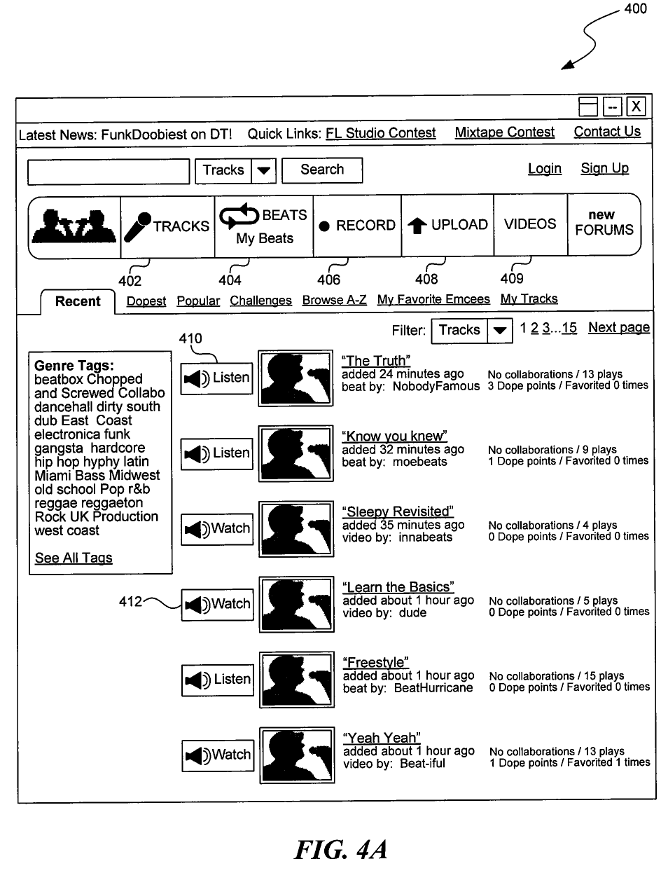

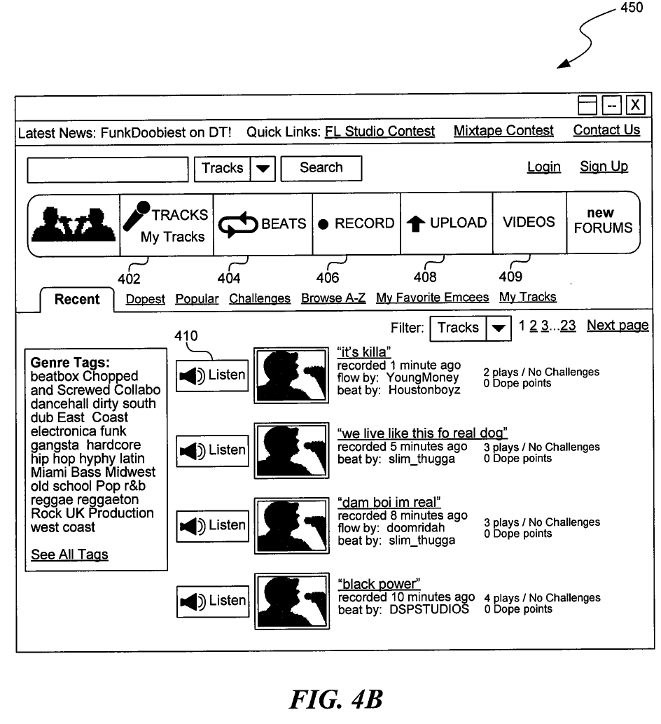

In some embodiments, the user interface module 214 generates and provides a user interface for a user to access additional functions and/or services, for example, music/video browsing, music/video sorting, music/video organizing, and/or challenge requesting, etc. Examples of user interfaces provided by the user interface module 214 and services accessible via the user interfaces can be visualized with further reference to the example user interfaces of screenshots in FIG. 4-6.

In one embodiment, the user interface module 214 identifies user requests and displays a listing of beats, tracks, and/or video content. The user request can be generated by an action indicating whether the user wishes to browse through beats, tracks, or video content, for example, via clicking on a tab associated with beats, tracks, or video content. The user interfaces showing listings of beats, tracks, or video content tracks are illustrated with further reference to FIGS. 4A-B, respectively. The user interface module 214, in some instances, provides additional information associated with each video, beat or track in the browsing interface. Additional information can include artist information, timing information, title information, etc.

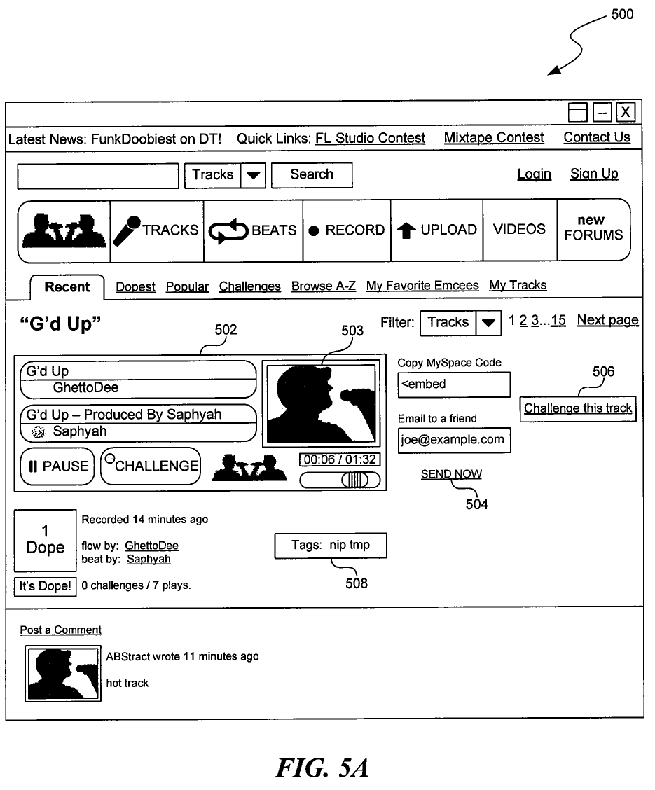

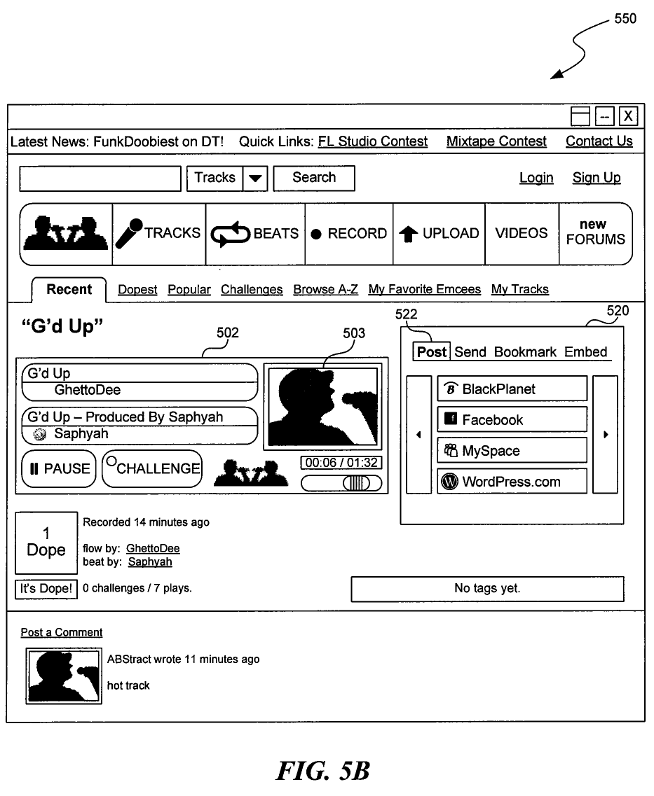

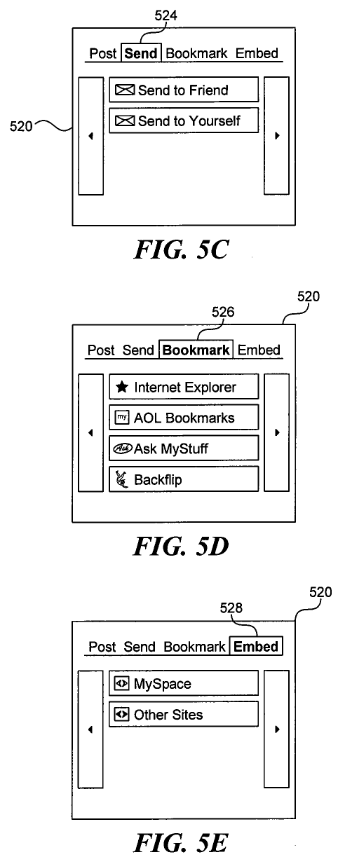

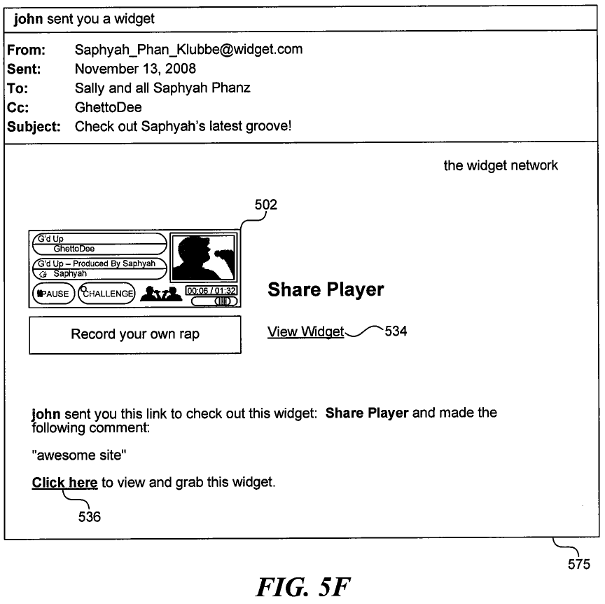

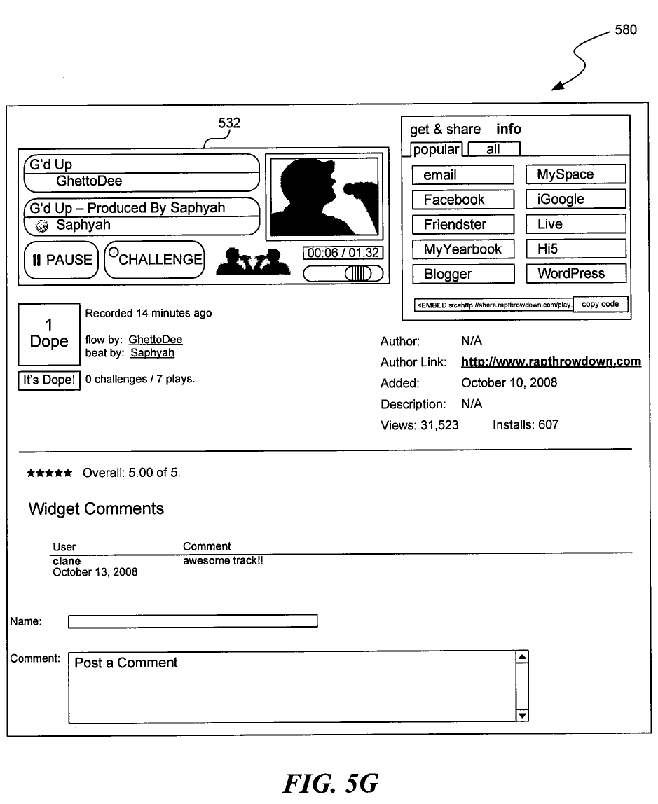

The user interface module 214, in some embodiments, detects selection of a video, a beat and/or a track through the listing entries and presents a page view for the selected listing, for example, with further reference to FIG. 5. The page view allows the user to further view detailed information regarding the selected multimedia content. The page view may further allow the user to request playback of the multimedia content. The user interface module 214 can adjust the functions and services available through the page view user interface, for example, dependent on whether the page view is for a video, a beat, or a track. In a page view of a video, a record button may be displayed such that a user can record audio over the video. In the page view of a beat, a record button is also typically displayed such that a user can generate a record request over the beat, for example, upon a mouse click on the record button. In the page view of a track, a challenge button is typically displayed such that users can request to challenge the track selected.

One embodiment of the user interface module 214 provides a user interface with an audio/multimedia player/recorder widget (e.g., the widget 502 of FIG. 5A-B) to facilitate multimedia content recording and playback over a network. The user interface can include a listing of selectable entries of mixed tracks. A mixed track generally includes a mix of a beat and a second audio track.

The user interface module 214 can also generate and provide, in the same or different user interface, a pause button to pause the playback of a performance art piece and/or a challenge button for a challenger to initiate a recording session of an audio track over a beat to generate a challenger track. The challenger track can be provided by another user to challenge other mixed tracks. The user interface can further include, for example, a record button for initiating a recording session and a stop button for terminating the recording session.

The user interface module 214 can further provide a text box in the audio/multimedia player/recorder widget to receive textual input representing a set of lyrics that complement the audio track and a selectable button in the audio player/recorder widget for setting the privacy attribute of the audio track.

In one embodiment, the user interface module 214 can generate and provide a sub-browser in the user interface that includes a listing of entries of a set of audio tracks representing a set of beats. Each entry can include information about a particular audio track. The sub-browser can include a first drop down box for selecting to view a listing comprising a first set of audio tracks in a first category and a second drop down box for selecting a listing of a subset of the first set of audio tracks that are of a sub-category of the first category.

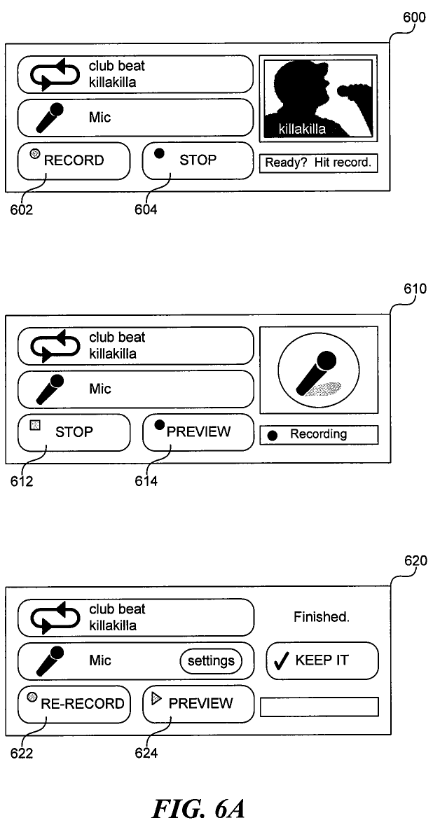

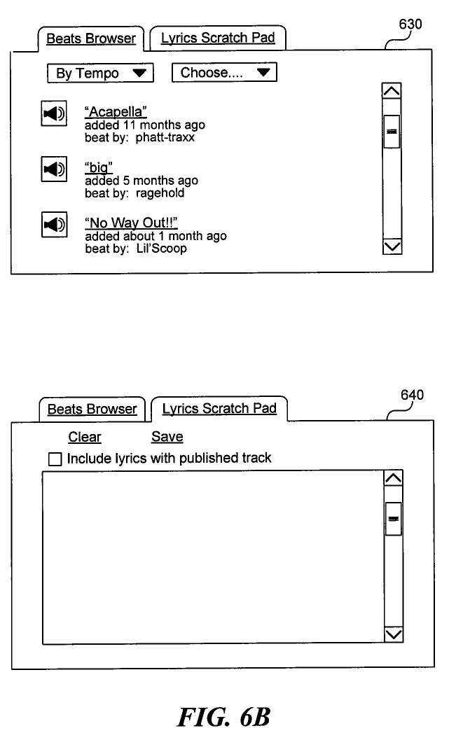

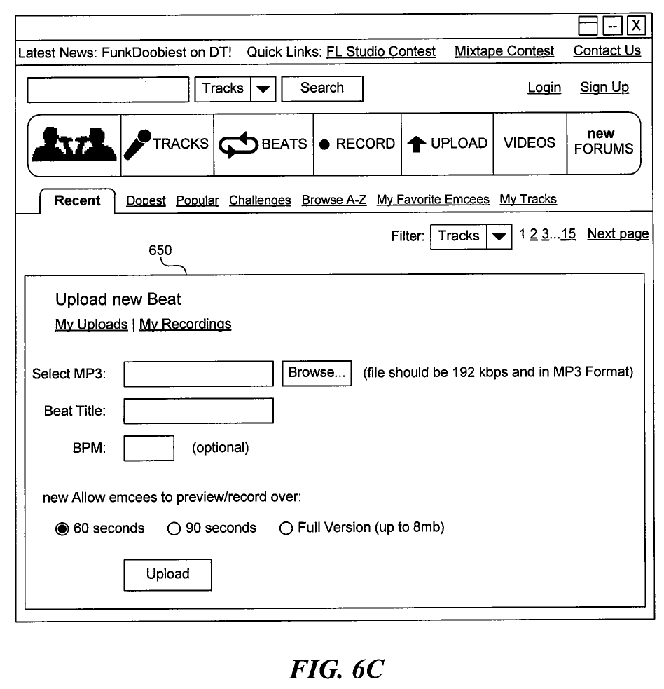

In some embodiments, the user interface module 214 adjusts buttons on a player according to the playback status of an audio track, for example, with further reference to FIG. 6A. When no playback is occurring, a play and/or record button can be displayed and are selectable. When playback is occurring, a stop/pause button is displayed and selectable. In addition, when a recording session has ended, for example, a re-record button and/or a preview button can be displayed.

In one embodiment, the user interface module 214 generates a graphical user interface widget (e.g., the widget 520 in FIG. 5B-E) and/or an audio player/recorder widget (e.g., the widget 502 in FIG. 5A-B). The audio player/recorder widget 502 may also be referred as a multi-media player/recorder widget. The widgets may be generated by the widget manager module 215.

The graphical user interface widget 520 is typically provided in a source platform hosted by the host server 200 where user shares audio or multimedia content and collaborates in musical creations using the audio player/recorder widget (or multi-media player widget). In the user interface, the graphical user interface widget 520 is typically linked to the audio player widget (or multi-media player widget) in the user interface as depicted by its orientation in the user interface (e.g., the user interfaces illustrated in the examples of FIG. 5B-5G).

The graphical user interface widget (e.g., the widget 520 of FIG. 5B) includes multiple options related to actions for migration of an instance of the audio player widget 502 (or multi-media player widget) to an external platform (target platform). The selected action related to migration of an instance of the audio player widget (or multi-media player widget) to a target platform can be performed by the widget manager module 215. The instance of the audio player widget (or multi-media player widget) in the external platform is typically available for access by the user via the target platform or users of the external platform.

The action related to migration of the instance of the audio player widget (or multi-media player widget) can include, posting the instance of the audio player widget (or multi-media player widget) to a profile page of the user or another user in the target platform. For example, a user in the host platform can post an instance of the audio player widget (or multi-media player widget) on his/her profile in an online social network. The online social network can be, by way of example but not limitation, Facebook, MySpace, BlackPlanet, and WordPress.com. The audio player widget (or multi-media player widget) may be available for access by the user's friends or connections in the online social network and/or additional select users. Migration of the instance of the audio player widget (or multi-media player widget) can include sending the instance of the audio player widget (or multi-media player widget) to an email account using a valid email address of the user. The instance of the audio player widget (or multi-media player widget) can also be shared with another user via email.

In one embodiment, an instance of the audio player widget (or multi-media player widget) can be book marked, for example, using any conventional or known website or web-browser including but not limited to, one or more of, Mozilla Firefox, Internet Explorer, AOL Bookmarks, Ask MyStuff, Backflip, BlinkList, BlogMarks, del.icio.us, Digg, Diigo, DropJack, Faves, Furl, Opera, Safari, Google Bookmarks, linkaGoGo, Live Favorites, My Yahoo!, Netvoiz, Newswine, Propeller, Reddit, Segnalo, Simpy, Spurl, StumbleUpon, Technorati, Twitter, and/or Yahoo! Bookmarks.

In general, the playlist accessible by the instance of the audio player widget in the target platform is programmable via the source (host) platform. For example, the user can select a set of mixed tracks or beats that he/she provided to be accessible in the external (target) platform. The user can further specify certain tracks to be accessible by connected users in the external platform and that other certain tracks be accessible to any visitor user. Similarly, the user can specify that certain tracks be private and not accessible by any other user in the external platform.

In one embodiment, the instance of the audio player widget (or multi-media player widget) in the target platform is operable to record an audio track and/or video content provided by a recording user in the external (target) platform. The recorded audio track and/or video can be shared with users in the source platform and/or users in the target platform. This setting is typically configurable and adjustable. In addition, the instance of the audio player widget (or multi-media player widget) in the external platform can be operable for a competing user to generate a competing track of a selected mixed track by recording an audio track over a beat from which the selected mixed track was generated. For example, a number of mixed tracks may be accessible for playback via the instance of the audio player widget (or multi-media player widget) in the external platform. The competing user may listen to the selected mixed track and select an option to challenge the mixed track using the instance of the audio player widget (or multi-media player widget). Generally, the audio player widget (or multi-media player widget) is operable to perform audio content and video content playback or recording.

The instance of the audio player widget can record and mix the challenger track. The challenger track can be made available for playback and further challenging in the external platform and/or the host platform, subject to settings by the competing user, for example.

One embodiment of the present disclosure includes a sharing module 218. The sharing module 218 can be any combination of hardware components and/or software agents able to manage, track, modify, and/or enforce the privacy attributes of audio content added to the service site in the host platform. The sharing module 218 may receive commands related to privacy attributes of user content. The audio content owner (e.g., recording user of an audio track, uploading user of an audio track, etc.) typically has the ability to set the privacy attributes of owned content. In some instances, other select users may have the ability to set and/or modify privacy attributes of audio content. A track may be private, public, private, shared, etc.

The sharing module 218 provides the recording user with privacy attribute settings for the recording user to configure access to the mixed track by other users such that the audio content owner (e.g., the recorder) can determine if a particular track is visible to other users, and if so, who it is visible to and/or the group of users that it is visible to. Specific conditions under which a particular track is visible to other users can be specifiable by the content owner. For example, other user may be able to listen to a predetermined duration of the particular track. In some instances, other users may have only viewing rights and not recording rights. When other users have recording rights, the owner user may also specify the conditions under which the track can be recorded over, for example, a particular duration of the track time. In some instances, a particular track may only be visible to other users but not available for playback, for example.

In one embodiment, the sharing module 218 further manages private mailboxes and delivery/receipt of mail for users in the host platform. The sharing module 218 can provide the user with a private mailbox accessible via the web-portal. The private mailbox is suitable for receipt of private messages from other users in the web-portal. The private messages can include voice-based or text-based messages. The voice-based messages may be uploaded or recorded. In one embodiment, the voice-based messages include the audio track or the audio track recorded over a beat or sound effects.

One embodiment of the present disclosure includes a competition module 220. The competition module 220 can be any combination of hardware components and/or software agents able to receive challenge requests to a track and records additional tracks to facilitate the challenge.

The competition module 220 can receive a user request to challenge a mixed audio track which is typically generated from a beat and a vocal expression. A user can request to generate another vocal expression (e.g., rap, sing, otherwise vocalize) over the same beat as the mixed audio track, for example, by clicking or otherwise selecting a tab or button on the service site.

The competition module 220 can initiate a recording session to capture audio detected by the user's audio input device (e.g., microphone) while performing audible playback of the beat to the user, for example, responsive to detection of a click of a pointing device on the challenge button in the user interface. Once the user is finished recording, the challenger track can be generated from combining or mixing the user's vocal expression with the same beat. In addition, the challenger track can be combined with a video or image to generate a performance art piece, such as a music video. The video or the image can be provided by the challenger or another user. In one embodiment, the competition module 220 also records the video of the challenger during the recording session.

The challenger track can be further made visible and/or accessible to users to listen to, for example. Other users can browse the challenge track and the original mixed track, typically on the same page. The challenge track and original mixed track can be rated and commented, for example. Any number of challenge tracks can be recorded for a given original mixed track. The competition module may be operable to manage rating of the challenger track relative to the original mixed track.

The host server 200 can be implemented using one or more processing units, such as server computers, UNIX workstations, personal computers, and/or other types of computes and processing devices. In the example of FIG. 2, the host server 200 includes multiple components coupled to one another and each component is illustrated as being individual and distinct. However, in some embodiments, some or all of the components, and/or the functions represented by each of the components can be combined in any convenient and/or known manner. For example, the components of the host server may be implemented on a single computer, multiple computers, and/or in a distributed fashion.

Thus, the components of the host server 200 are a functional unit that may be divided over multiple computers and/or processing units. Furthermore, the functions represented by the devices can be implemented individually or in any combination thereof, in hardware, software, or a combination of hardware and software. Different and additional hardware modules and/or software agents may be included in the host server 200 without deviating from the spirit of the disclosure.

FIG. 3A depicts a block diagram illustrating a user database 328 that stores user profile information and user content, according to one embodiment.

In the example of FIG. 3A, the database 328A can store user profile data, including data related to user information and/or user subscription information. For example, user profile data can include descriptive data of personal information such as, but is not limited to, a first name and last name of the user, a valid email ID, a unique user name, age, occupation, location, education, home town, gender, URL of home page, contact information, membership information, musical influences, favorite musicians, fans, ethnicity, etc. User profile data may further include interest information, which may include, but is not limited to, activities, hobbies, photos, etc.

In one embodiment, user profile data stored in database 328A is explicitly specified by the user. For example, when the user (e.g., visitor/service subscriber) signs up for web-access of musical collaboration services, a set of information may be required, such as a valid email address, an address of service, a valid credit card number, social security number, a username, and/or age. The user information form can include optional entries, by way of example but not limitation, location, activity, hobbies, ethnicity, photos, etc.

The database 328 can also store user content and/or data related to information of user content (e.g., user content data/metadata), for example, in database 328B. User content and user content metadata can either be explicitly submitted by the user or provided via one or more software agents and/or hardware modules coupled to the database 328B. For example, a user can upload user content to be stored in database 328. The user content can include user generated/created audio content that was recorded offline and later uploaded. User content can also be recorded over a network in real-time or near real-time and stored in the database 328B.

User content metadata can, in some instances, be automatically identified and stored in the database. In particular, audio content metadata or multimedia content metadata include by way of example but not limitation, bitrate, format, compression information, genre, tempo, sound quality, video quality, resolution, artist, owner, spectral information, etc. Examples of audio content data stored in the database include those shown in 328B, but is not limited to, tracks recorded by users, beats recorded and/or uploaded by users, lyrics, comments, ratings, and/or challenges.

FIG. 3B depicts a block diagram illustrating a content database 330 to store audio content 330A, audio content metadata 330B and/or 330C, according to one embodiment.

In the example of FIG. 3B, the database 330A stores audio content, including, but not limited to, recently added tracks/beats, most used beats, highest rated (e.g., “Dopest”) tracks/beats, most popular tracks/beats, challenges, etc. Audio content stored in the database 330A is typically user generated and/or user provided. The database 330A may be externally coupled to a database manager to sort the content, based on, popularity and/or ratings, for example.

The database of 330B stores beats (e.g., rhythms) and information related to the beats. Information of each beat (e.g., beat metadata) can include by way of example but not limitation, the title of the beat, the name of the artist, the length of the beat in time (timing data), date the beat was recorded/uploaded, the number of times the beat has been played, tags, the genre, the tempo (tempo data), comments, and/or ratings (rating data). Beat metadata is, in some embodiments, manually submitted by one or more users. Beat metadata may also be automatically identified by an external agent coupled to the database 330B. For example, spectral analysis may be performed to determine tempo information. A track may be automatically tagged with identifiers indicating the track genre (e.g., “hip hop”, “east coast”, “west coast”, etc.).

The database 330C stores tracks (e.g., voice expressions recorded over beats) and information related to each track. Track information (e.g., or track metadata) can include, for example, title of the track, title of the beat, artist of the beat, name of track artist, length of track in time, date the track was recorded/uploaded, number of times the track has been played, tags, genre, tempo, lyrics, comments, ratings, and/or challenges. Similar to beat metadata, track metadata can be obtained based on user supplied information or automatically identified.

FIG. 4A illustrates an example user interface 400 of a listing of recently added tracks, according to one embodiment.

The example user interface 400 includes a number of selectable tabs allowing the user to select to view a listing of track entries (e.g., tab 402), beat entries (e.g., tab 404), or video entries (e.g., tab 409). The record tab 406 and the upload tab 408 are also selectable for a user to record or upload multimedia content including audio or video content. User interface 400 is a listing of beat entries when the beats tab 404 is selected. The listing includes multiple beats based on the applied filter (e.g., last 24 hours, last week, last month, etc.) selected. Each listing can include a display of information related to the beat, including but not limited to, the title of the beat, when the beat was added (e.g., recorded or uploaded), user name of artist, number of plays, and/or ratings information. Each listing can, in some instances, include an icon uploaded by the artist.

In addition to viewing the recently added beats, the user interface 400 also includes selectable tabs for users to select to view listings of most used beats, highest rated beats (e.g., “Dopest”), most popular beats, and/or to browse an alphabetical listing of the beats. In some embodiments, users can maintain a list of favorite beatmakers (e.g., artists) and a list of the user's beats. These options are also selectable in the tabs of user interface 400. When a favorite beatmaker is selected, a list of beats provided by the beatmaker is displayed to the user, in some instances, with additional user information related to the beatmaker.

In one embodiment, each entry listing with audio content includes a listen icon 410 that is clickable by a user to request playback of the beat associated with the entry listing. When the listen icon 410 is clicked, another user interface for the beat can be displayed. The user can comment on the beat on this page for example. The user can also add the beat as a favorite beat. Additional information regarding the beat, such as, tags, comments and/or ratings can be shown on this page, as illustrated with further reference to the example user interface of FIG. 5. In one embodiment, each entry listing with video content includes a watch icon 412 that is clickable by a user to request playback of the video associated with the entry listing. In general, video content is associated with audio content and upon request of video playback, the associated audio content is aurally played as well.

FIG. 4B illustrates an example user interface 450 of a listing of recently added beats, according to one embodiment.

User interface 450 is a listing of track entries displayed in response to selection of the tracks tab 402. The listing can show multiple tracks based on the applied filter (e.g., last 24 hours, last week, last month, etc.). Each listing can include a display of information related to the track, including but not limited to, the title of the track, the title of the beat, user name of the beat artist, user name of the track artist, when the track was added (e.g., recorded or uploaded), number of plays, and/or ratings information (e.g., number of dope points). Each listing can, in some instances, include an icon uploaded by the artist.

In addition to viewing the recently added tracks, the user interface 450 also includes selectable tabs for users to select to view listings of most used tracks, highest rated tracks (e.g., “Dopest”), most popular tracks, and/or to browse an alphabetical listing of the beats. In some embodiments, users can compile and maintain a list of favorite M.C.s (e.g., artists) and a list of the user's own tracks. These options are also selectable in the tabs of user interface 450. When a favorite artist is selected, a list of tracks created by the artist is displayed to the user, and in some instances, with additional user information related to the artist.

In one embodiment, each entry listing includes a listen icon 410 clickable by a user to listen to the track associated with the entry listing. When the listen icon 410 is clicked, another user interface for the track can be displayed to the user. The user can comment on the track on this page, for example. The user can also add the track as a favorite track. Additional information regarding the track, such as, tags, comments and/or ratings can be shown on this page, as illustrated with further reference to the example user interface of FIG. 5.

FIG. 5A illustrates an example user interface 500 having an audio player/recorder widget (or multimedia player/recorder widget) 502 for playing a track, according to one embodiment.

The user interface 500 includes the audio player/recorder widget 502 (or multimedia player/recorder widget) with selectable buttons for pausing and/or stopping playback of an audio track and/or a video. A play button is, in most instances displayed when playback of audio or video is not occurring. The audio player/recorder widget 502, in some embodiments, also displays the name of the video, track, and/or beat being played. Name of the artist(s) may also be displayed in the player 502. The video content or image content can be displayed in the display 503 during playback. If no video content is available, an icon may be displayed in the 503 in place of other images or video.

In one embodiment, the audio player/recorder widget 502 (or multimedia player/recorder widget) includes a challenge button. The challenge button is typically displayed when a track (e.g., vocal expression mixed with a beat) is displayed in the audio player/recorder widget 502 or currently being played. In one embodiment, the challenge button allows a user to record over the same beat as that used in the track listed in the audio player/recorder widget 502. The challenge button may also allow a user to record video over a track or beat.

For example, the user can generate a vocal expression (e.g., rap, sing, speak, and/or any other form of vocalization) or a physical gesture/act that can be recorded with a beat when the challenge button is clicked. The track representing the beat is usually simultaneously played back during the recording session triggered by the challenge button. In some embodiments, the user interface includes another challenge button 506 (“Challenge This Track”) displayed outside the audio player/recorder widget 502.

Once the challenge button is selected, a recording session generally begins with the detection of the recording user's audio or video input device (e.g., microphone). Once the input device is accessible, the user can click the record button of the audio player/recorder widget 502 (or multimedia player/recorder widget) to initiate a recording session over the beat or any other selected multimedia content. The user can stop the recording anytime by clicking the stop button of the audio player/recorder widget 502. The user interface display of audio player/recorder widget 502 may be different before recording, during the recording session, and after the recording session. The different user interface displays are illustrated with further reference to FIG. 6A.

After the recording session, the recording user is presented with the options of previewing the recording mixed with the selected multimedia content (e.g., a selected beat), re-recording the audio or video content, and/or saving the mixed multimedia content. In one embodiment, when the user saves the recorded content, the recorded content is published and listed as a challenge to the original content. Tracks that are challenges to one another may be displayed and indicated as such that users can browse different vocal expressions or physical gestures (e.g., rap, sing, etc.) recorded over the same beat or the same multimedia content. Perusing users can comment as well as rate the challenges.

In some embodiments, the audio player/recorder widget 502 (or multimedia player/recorder widget) is portable and compatible among different web sites. For example, the audio player/recorder widget 502 (e.g., for playing and/or recording) can be hosted by various websites such that audio/video playback and/or recording can be achieved when a user is browsing any website hosting the player. Websites may host the audio player/recorder widget 502 using embedded codes. The widget 502 can be installed on demand (e.g., user event triggered via click through) and/or hardcoded. For example, when a user requests access to multimedia content or recording of multimedia content, the website can generate a request to install the audio player/recorder widget 502. The audio player/recorder widget 502 can, in some embodiments, be uninstalled after the user session.

Additionally, the audio player/recorder widget 502 can be installed via a widget and/or an applet on user content sharing sites. For example, users can add the audio player/recorder widget 502 to their personalized space in a social networking site (e.g., Friendster, Facebook, Linkedin, etc.). When other users visit the personalized space, the audio player/recorder widget 502 may be accessible for multimedia playback, recording, and/or mixing purposes to generate performance art pieces.

FIG. 5B illustrates an example user interface 550 having the audio player/recorder widget 502 and a graphical user interface widget (“widget”) 520 to facilitate multimedia content sharing, collaboration, and competition among multiple platforms, according to one embodiment.

The graphical user interface widget 520 is provided in the user interface 550 interface in a source (host) platform where a first set of users share audio and multimedia content and collaborate in musical or performance creations using the audio player widget 502 (or multimedia player/recorder widget). The graphical user interface widget 520 is typically linked to the audio player widget 502 (or multimedia player/recorder widget) in the user interface 550 in such a manner that, for example, the instance of the audio player widget 502 that has been migrated to an external platform can be used to access the multimedia content being played back in the widget 502 in the source platform.

The graphical user interface widget 520 includes many selectable options related to migration of an instance of the audio player widget in the graphical user interface widget in the source platform to a target (external) platform. In the example of FIG. 5B, the “post” option 522 is illustrated. The post option 522 may allow users to post the instance of the audio player widget 502 to a profile page of the user or another user in the target platform (e.g., BlackPlanet, Facebook, MySpace, etc.). The instance of the audio player/recorder widget 502 may then be accessed in the target platform for multimedia content playback or recording purposes.

FIG. 5C-E illustrate further examples of the graphical user interface widget 520, according to one embodiment.

In the example of FIG. 5C, the “send” option 524 is illustrated. The send option 524 may allow users to send an instance of the audio player widget (or multimedia player/recorder widget) to an email account (e.g., to a friend or to him/herself). The instance of the audio player/recorder widget may then be accessed via a link in an email message delivered to the specified email account. An example of the email message and audio widget accessed via the email is illustrated with further references to FIG. 5F-G.

In the example of FIG. 5D, the “bookmark” option 526 is illustrated. The bookmark option 526 may allow users to bookmark the instance of the audio player widget (e.g., via Internet Explorer, AOL Bookmarks, etc.). The instance of the audio player/recorder widget may then be accessed via a link in the bookmarks of a browser. In the example of FIG. 5E, the “embed” option 528 is illustrated. The embed option 528 may allow users to embed the instance of the audio player widget (e.g., MySpace or other sites, etc.) such that the instance of the widget may be accessed via other sites for multimedia content (e.g., audio, video, etc.) playback or recording purposes.

FIG. 5F illustrates an example user interface of an email message 575 containing a link 534 and 536 to an instance of an audio player/recorder widget (or multimedia player/recorder widget), according to one embodiment. When the links 534 and 536 are accessed, a web-page containing an instance of the audio player/recorder widget 532 opens up. The web-page is illustrated with further reference to the example of FIG. 5G. FIG. 5G illustrates an example user interface 580 of the instance of the audio player/recorder widget (or multimedia player/recorder widget) linked 532 from the email message, according to one embodiment.

FIG. 6A illustrates example user interfaces of the audio player/recorder widget (or multimedia player/recorder widget) for recording over a beat, according to one embodiment.

Screenshot 600 is an example user interface of a widget (e.g., multimedia player/recorder widget) suitable for controlling audio or video playback and audio or video recording. The example user interface of screenshot 600 illustrates the widget interface while it is playing a track that represents a beat. In one embodiment, while a beat is being played, the widget includes a record button 602 and a stop button 604. The stop button 604 can be used to pause and/or stop playback of the multimedia content currently being played.

In one embodiment, the record button 602, when selected by a user, allows the user to record over the beat or video currently being played. The record button 602 can be used by the recording user to generate an initiation request to initiate the recording session. The initiation request is typically generated by a single action (e.g., a click of the pointing device) on the record button 602. For example, when the record button 602 is activated, playback of the beat is stopped if the beat is currently playing. A countdown to the initiation of the recording session thus begins. In most instances, if the user is recording over a beat, the beat is simultaneously played at the initiation of the recording session.

The example user interface of screenshot 610 illustrates the widget interface while it is recording an audio track over a beat (e.g., “club beat” by “killakilla”). In addition, recording sessions can be performed without a beat, for example, acapella. In one embodiment, during the recording session, the widget includes a stop button 612 and a preview button 614. The widget may also include an indicator of the recording status and a time indicator. The stop button 612 is, in most instances, used to stop the recording session. For example, the stop button 612 can be used by the user to generate a termination request to terminate the recording session (e.g., by a click of a pointing device on the stop button). In one embodiment, the preview button 614 is activated and becomes selectable once the recording session has been stopped. The preview button 614, when selected, allows the recording user to listen to the mixing results of the recording and the track.

The example user interface of screenshot 620 illustrates the widget interface after the recording session has ended. In one embodiment, the widget interface display includes a re-record button 622 and a preview button 624 after the recording session has ended. The widget may also include a save button (“KEEP IT”) for the user the save the mixed track. If the user is unsatisfied with the recording results and/or the mixing results, the re-record button 622 can be selected to start another recording session, over the same beat if a beat was originally used. The preview button 624 can be activated to listen to the results of the recording and/or mixing.

FIG. 6B illustrates example user interfaces of a beat browser 630 and a lyrics text box 640, according to one embodiment.

The example user interface of screenshot 630 includes a sub-browser (e.g., beats browser) having a listing of entries associated with beats (or rhythms, melodies). Each entry, as shown, may include information about the audio track. For example, time/date when the beat was recorded and/or uploaded and artist information can be included. The sub-browser, in some embodiments, includes a drop-down box for selecting to view audio tracks of a particular category. For example, the categories can include, favorite beats, recently added beats, most used beats, A-Z listing of beats, beats by genre, beats by tempo, etc.

In some embodiments, the sub-browser includes another drop-down box for selecting a subcategory of listings in the category selected by the first drop-down box. For example, sub-categories, rap, hip-hop, east coast, funk, west coast, etc. of the category ‘genre’. The drop down box can also be used to select a specific tempo or a range of tempos, for example.

The example user interface of screenshot 640 includes a text box, suitable for, lyric submission. Once a user has recorded and/or published a track, lyrics are selectively published along with the saved track to other users. In some embodiments, the lyrics are saved without being published to other users. In one embodiment, the text box auto-saves content entered into the text box by detecting activity.

FIG. 6C illustrates an example user interface 650 for uploading a beat, according to one embodiment.

The example user interface of screenshot 650 includes a set of fields suitable for uploading audio files. For example, the interface includes a browse button for the user to locate the files they wish to upload. The user interface, in some embodiments, allows the user to submit the title of the file (e.g., audio track, beat) and/or the tempo of the audio track (e.g., in beats per minute, BPM). In addition, the owner of the uploaded audio file can pre-configure the length of duration in time of their audio file over which another user can record.

For example, the owner can allow other users (e.g., M.Cs.) to record over their tracks for a few seconds, a few minutes, or over the full length of the track (e.g., 30 s., 60 s., 90 s., 2 min., full length, etc.). The setting can be adjusted as necessary. The settings can be configured by selecting the box associated with the appropriate amount of time as illustrated in the example user interface. The settings can also be manually specified, for example, in a text-box (not shown).

In one embodiment, when a track is uploaded, the owner can set the accessibility (e.g., privacy settings) of the track. For example, the track may be visible to the public or only visible to the owner and/or other select users. Additional privacy settings that specify rules governing other user's rights to record over the track can be configurable by the track owner as well.

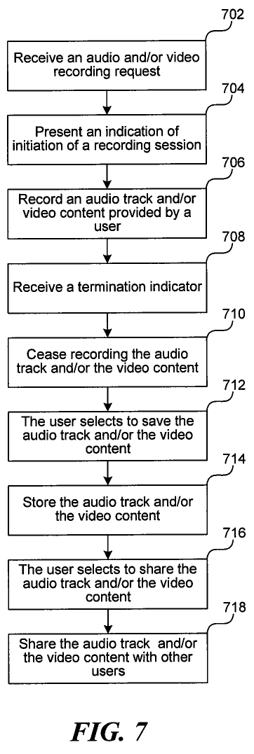

FIG. 7 depicts a flow diagram illustrating an example process of recording an audio track or video content over a network, according to one embodiment.

In process 702, an audio and/or video recording request is received. The request is typically received over a network via the multimedia collaboration service site. Using the user interface options provided by the service site, the user, in some embodiments, selects the tab on the user interface associated with recording audio and/or video content. When the tab has been selected, a record button may be presented to the user, that when selected, generates an audio and/or video recording request. Other known and/or convenient methods for a user to generate an audio and/or video recording request are contemplated and are considered to be within the novel art of this disclosure.

In process 704, an indication of initiation of the recording session is presented to the user. When a user requests to record audio and/or video content, synchronization between the time the recording begins and the time a musical or theatrical production (e.g., vocal expression such as singing, rapping, instrumental performance, speech, physical gestures, acts, skits, etc.) begins, facilitates in obtaining optimal recordings. Therefore, the service site, in some embodiments, presents one or more indications of recording session initiation.

A number of known and/or convenient methods to present such an indication are contemplated and are considered to be within the novel art of this disclosure. For example, the service site can present a visual indicator that the recording session is to begin. The visual indication may be a numerical countdown and/or a literal expression (e.g., lights, camera, record). Aural indicators are in some embodiments used as well, including an audible countdown or audible instructions indicating initiation of the recording session.

In process 706, an audio track and/or video content provided by the user is recorded. The user can begin the musical and/or theatrical production when the recording session begins. The musical and/or theatrical production is typically produced in the vicinity of an input device (e.g., microphone or web-cam) coupled to a computer system connected to the service site via a network. While recording, audio input to a microphone and/or video input to a web-came or other imaging devices can be recorded in real-time or near real-time.

In process 708, a termination indicator of termination of the recording session is received. The user can manually stop the recording session, by, for example, clicking the stop button on the user interface. In some embodiments, recording sessions may be terminated automatically after a predetermined amount of time has elapsed. The predetermined amount of time may be user configured, for example. When the termination indicator is received, in process 710, recording of the audio track or video is ceased. Through the user interface, the user can preview the results of the recording by listening to the recorded audio track and/or viewing the recorded video content. In some embodiments, the recorded track is mixed with a beat to generate a mixed track and the recorded video content can be mixed with other media content to generate a performance art piece. The mixed track and/or the performance art piece may also be previewed by requesting playback via the service site. Based on the results of the preview, the user can select to save discard the content. In addition, the user can select to start another recording session.

In process 712, the user selects to save the audio track and/or video content. The audio track and/or video content can be saved on a system database affiliated with and/or managed by the service site. The user can accesse the saved content via the service site. Additionally, the user can manage multiple listings of multimedia content saved through the service site and access the listing via the web interface. In addition, the user can optionally share saved content with other users, for example, in process 714. Each saved content can have its own privacy settings governing visibility, accessibility, rights to edit the track, and/or rights to record over the content, etc.

In response to the user request to share the track with others, a listing entry of the content is published on the service site. Depending on the type of multimedia content, for example, whether an audio track is a beat or a mixed track, or video content, the listing entry can be published in different pages. In addition to the type of multimedia content, the recording can be further classified based on genre, popularity, tempo, in alphabetical order, etc. The listing entry is typically selectable by other users for playback and/or to obtain additional information about the associated multimedia content. For example, the listing entry can include, by way of example but not limitation, artist information, tags, genre information, timing information (e.g., when created, recorded, and/or uploaded) comments, ratings, and/or challenges to the multimedia content.

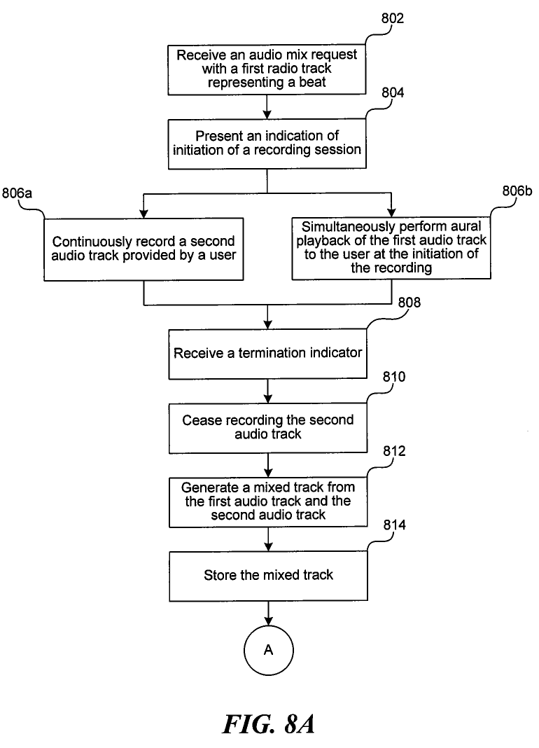

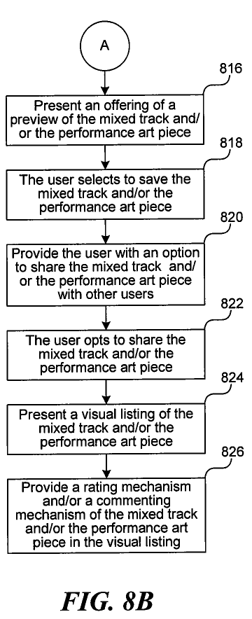

The listing entry is, in some embodiments, selectable by other users for commenting and/or rating purposes. If the listing entry is associated with a mixed track (e.g., vocal expression mixed with a beat), other users have the option of challenging the mixed track by generating their own vocal expressions over the same beat. The challenger tracks and the challenged tracks are typically available for viewing and playback by third party users. If the listing entry is associated with a beat, users have the option of recording (e.g., vocal expressions) over the beat to generate a mixed track. An example process for generating a mixed track is illustrated with further reference to FIG. 8A.

FIG. 8A depicts a flow diagram illustrating an example process of generating a mixed track, according to one embodiment.

In process 802, an audio mix request with a first audio track representing a beat is received. The requesting user may come across a beat to his/her liking while browsing and listening to beats via the service site. While performing playback of the beat, the user can select to record a sound production over the beat. The user interface player, in this situation, can automatically pause/stop playback of the beat. The user can also pause playback of the beat and then select to record over the beat.

When the record request is received, in process 804, an indication of initiation of a recording session is presented via the service site. The indication facilitates synchronization of the recording process and audio content generation by the user. The indication can be provided via one or more of any known and/or convenient methods as described with further reference to FIG. 7.

In process 806A-B, a second audio track provided by the user is recorded while simultaneously performing aural playback of the first audio track (e.g., the beat) at the initiation of the recording session. The first audio track is generally automatically audibly played back during a mixing session. The playback volume may in some instances be user adjustable. In process 808, a termination indicator to terminate the recording session is received. The recording session may be terminated manually by the recording user. The recording session may be automatically terminated after a predetermined amount of time configurable by the user or predetermined by the system. In process 810, the recording of the second audio is ceased when the termination indicator is received.

In process 812, a mixed track is generated from the first audio track and the second audio track provided by the user. The first audio track typically represents a beat that the user recorded over. In one embodiment, the first audio track comprises the beat of a rap song and the second audio track comprises lyrics of the rap song. For example, the user may have rapped over the beat, or otherwise generated an audio track to be mixed with the beat. The user may have sung over a rhythm or melody, for example. The resulting mixed audio track may be previewed by the recording user and saved. In one embodiment, a third audio track comprising lyrics of the rap song or another rap song is recorded over the same beat. In process 814, the mixed track is stored. The process continues with sharing the stored mixed track with other users with further reference to FIG. 8B.

FIG. 8B depicts a flow diagram illustrating an example process of sharing a mixed audio track or performance art piece with other users, according to one embodiment.

In process 816, an offering of a preview of the mixed track and/or a performance art piece is presented to the user, for example, via the user interface. The user can preview the results of the mixing and determine whether the mixed track and/or performance art piece is to be saved. In one embodiment, a preview button on the user interface is used to listen to the mixed track or to view the performance art piece. The user can also select to discard the mixed track and/or the performance art piece, for example, if the results were unsatisfactory. In process 818, the user selects to save the mixed track and/or the performance art piece. When a track and/or the performance art piece are saved, typically the user is provided with an option to share the mixed track and/or the performance art piece with other users, as in process 820.

The owner can save the track but keep it private such that the saved content is only visible and/or accessible to the owner, and/or select users. In process 822, the user selects to share the performance art piece with other users. The performance art piece may thus be visible to other users and accessible by other users, for example, for playback purposes.

When a performance art piece is shared by the owner with other users, the service site can publish a selectable entry listing for the performance art piece, as in process 824. In process 826, a rating mechanism and/or a commenting mechanism of the performance art piece is provided in the visual listing. For example, a clickable icon (e.g., “Dope” icon) is clickable by users to indicate liking for a video, a track or beat. In addition, the service site tracks number of views, plays, and/or challenges of a particular performance art pieces to determine popularity, for example.

Each visual listing can be selected by users to obtain additional information about the performance art piece or to playback the performance art piece. For example, users can determine the name of the beat and the name of the track recorded over the beat, artist information, genre, tempo, tags, etc. A shared performance art piece or mixed track can be challenged by other users, in one embodiment. Typically, other user can request the challenge by selecting the challenge option or clicking the challenge button associated with a particular track.

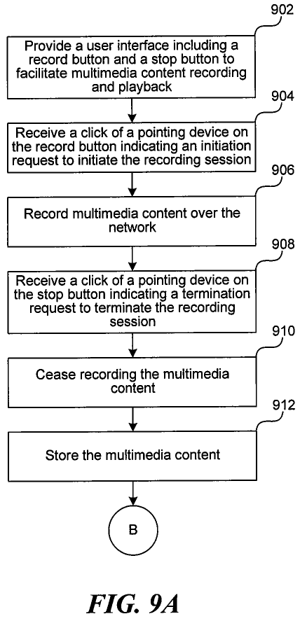

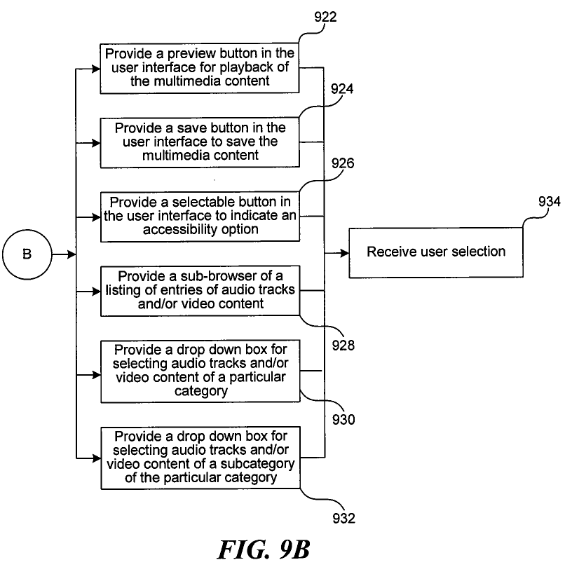

FIG. 9A depicts a flow diagram illustrating an example process of recording an audio track or video content over a network via a click of a pointing device, according to one embodiment.

In process 902, a user interface including a record button and/or a stop button is provided to facilitate multimedia (e.g., audio and/or video) content recording and/or playback. The user interface is, in one embodiment, illustrated with further reference to FIG. 6A. The user interface can be a player with a record button and/or a stop button. The record button is, in one embodiment, selectable with a single click of a pointing device (e.g., a mouse, a stylus, a pointer, etc.) to generate a request for a recording session.

In process 904, a click of the pointing device indicating an initiation request to initiate the recording session is received. The request triggers the start of a recording session. The service site establishes connectivity to an audio input device, and, in process 906, multimedia content is recorded from audio/video input detected from an input device (audio and/or video input device).

In process 908, a termination request to terminate the recording session is received. The termination is, in one embodiment, generated by a click of the pointing device on the stop button. The termination request can also be automatically generated after a predetermined amount of recording time, specifiable by the recording user, for example. In process 910, the recording of the multimedia content is ceased. In process 912, the audio track is optionally temporarily stored. For example, the multimedia content is temporarily stored in memory until the user decides to save it or to discard it. The multimedia content may also be temporarily stored for the recording user to preview the results. After the multimedia content is temporarily stored, the user can be presented with various options selectable via the user interface, for example, with further reference to FIG. 9B.

FIG. 9B depicts a chart illustrating an example list of user interface buttons that can be generated to receive user selection, according to one embodiment.

In process 922, a preview button is provided in the user interface for playback of the multimedia content to preview a newly recorded/added video, track or beat. In process 924, a save button is provided in the user interface to save the multimedia content. In process 926, a selectable button is provided in the user interface to indicate an accessibility option. For example, the button associated with multimedia content can be selected to indicate the privacy attribute (e.g., public, shared, protected, and/or private).

In process 928, a sub-browser of a listing of entries of beats is provided. In process 930, a drop-down box is provided for selecting multimedia content of a particular category to be displayed in the sub-browser. For example, categories can include, favorite tracks, most recent tracks, most popular tracks, genre, tempo, A-Z listing, etc. In process 932, a drop-down box is provided for selecting multimedia content of a sub-category of a category. For example, the category genre may have sub-categories including but not limited to, pop, latin, jazz, hip-hop, electronica, funk, rock, Miami bass, opera, movie, skit, play, comedy, romance, etc.

Illustrations of the example user interface buttons are provided with further references to FIGS. 4-6.

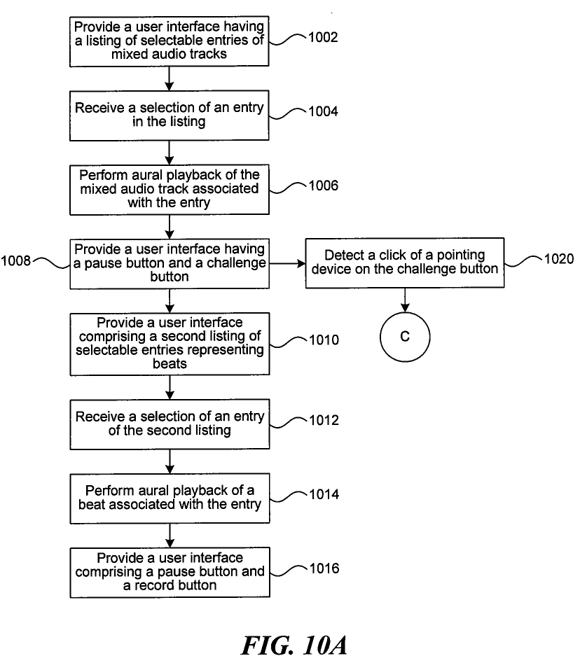

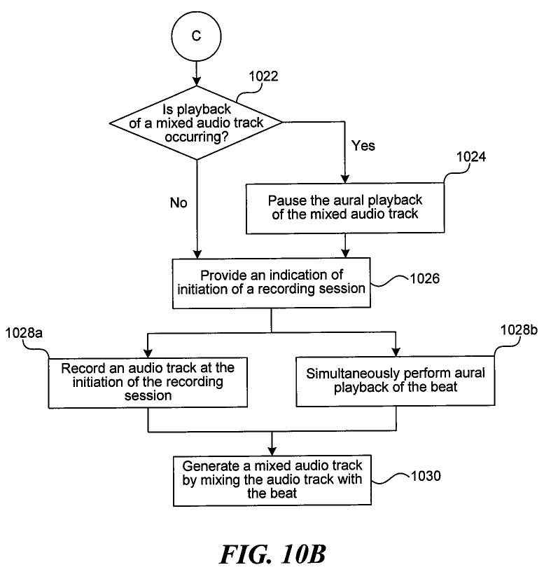

FIG. 10A depicts a flow diagram illustrating an example process of providing a user interface having listings of mixed audio tracks and beats, according to one embodiment.

In process 1002, a user interface having a listing of selectable entries of mixed audio tracks is provided. The user interface of mixed audio tracks can be provided in response to user request. The user request is, in some embodiments, generated by a user when the user selects a tab (e.g., the tab “tracks”) in the user interface associated with mixed audio tracks. Mixed audio tracks are tracks that have mixed within, two or more audio tracks. Typically, a mixed audio track is a track representing a beat (e.g., rhythm, beat, melody, instrumental production, etc.) mixed with another track representing a vocal expression (e.g., singing voice, talking voice, speech, dialogue, hum, whistle, rap, and/or any other form of vocal mutterings). In some embodiments, mixed audio tracks can have mixed within, multiple beats. An example user interface of a listing of mixed audio tracks is illustrated with further reference to FIG. 4B.

In process 1004, a selection of an entry in the listing is received. The entry selection is, in some embodiments, generated when the user clicks on a hyperlink associated with the entry. In most instances, multiple hyperlinks are associated with each entry. For example, the entry may include hyperlinks to artist information, hyperlinks to track information, and/or hyperlinks to initiate playback of tracks.

In process 1006, aural playback of the mixed audio track associated with the selected entry is performed. A playback request can be generated when relevant icons are clicked or otherwise selected by a user.

In process 1008, a user interface having a pause button and a challenge button is provided, when playback is occurring. The pause button can be used to pause and/or stop playback of the mixed audio track. In addition, when a track is being played back, a challenge button is provided in the user interface (e.g., in the player or elsewhere on the web page). When a mixed audio track entry is selected, users have the option of challenging the mixed audio track by recording another track over the same beat used in the mixed audio track. In process 1020, a click of a pointing device on the challenge button. The example process of challenging a track is illustrated with further reference to FIG. 10B.

In process 1010, a user interface comprising a second listing of selectable entries representing beats is provided. The listing of beat entries can be provided in response to a user request. For example, the user request is typically generated when the associated tab in the service site is clicked and/or otherwise selected. A beat typically refers to an audio content having melody (e.g., rhythms) without lyrical expressions.

In process 1012, a selection of an entry of the second listing is received.The entry selection is, in some embodiments, generated when the user clicks on a hyperlink associated with the entry. In most instances, multiple hyperlinks are associated with each entry. For example, the entry may include hyperlinks to artist information, hyperlinks to beat information, and/or hyperlinks to initiate playback of the beats. In process 1014, aural playback of the beat associated with the entry is performed. A playback request can be generated when relevant icons are clicked or otherwise selected by a user.

In process 1016, a user interface comprising a pause button and a record button is provided. The pause button can be used to pause and/or stop playback of the beat. In addition, when a beat is being played back, a record button is provided in the user interface (e.g., in the player or elsewhere on the web page). When a mixed audio track entry is selected, users have the option of recording another audio track over the beat.

FIG. 10B depicts a flow diagram illustrating an example process of facilitating challenges between users, according to one embodiment.

In process 1020, a click of a pointing device on the challenge button is detected. One or more challenge buttons are typically displayed when a mixed audio track is being played. A user can generate a challenge request by clicking on one or more of the challenge buttons. When a challenge request is requested for a particular track (e.g., typically the track displayed on the service site), in process 1022, the system determines whether a mixed audio track is currently playing. If the system determines that a mixed track is currently playing, in process 1024, the aural playback of the mixed audio track is paused for preparation of recording another audio track from the user to challenge the mixed track.

If no playback is occurring, in process 1026, an indication of initiation of a recording session is provided. As previously described, the indication can be aural and/or visual for facilitating synchronization of initiation of the recording process and user's sound production efforts. In process 1028A-B, an audio track is recorded at the initiation of the recording session while simultaneously performing aural payback of the beat used in the mixed audio track.

In process 1030, a mixed audio track is generated by mixing the audio track with the beat. In the situation of a challenge, the beat is the same beat as that used in the original mixed track the user requested to challenge. The generated challenge track, once shared with other users, can be displayed on the same page as the original mixed track to which the challenge was requested. Other users can access the original mixed track and the challenge track, typically via one user interface. In some embodiments, other users can rate and/or comment on the original mixed track and the challenge track.

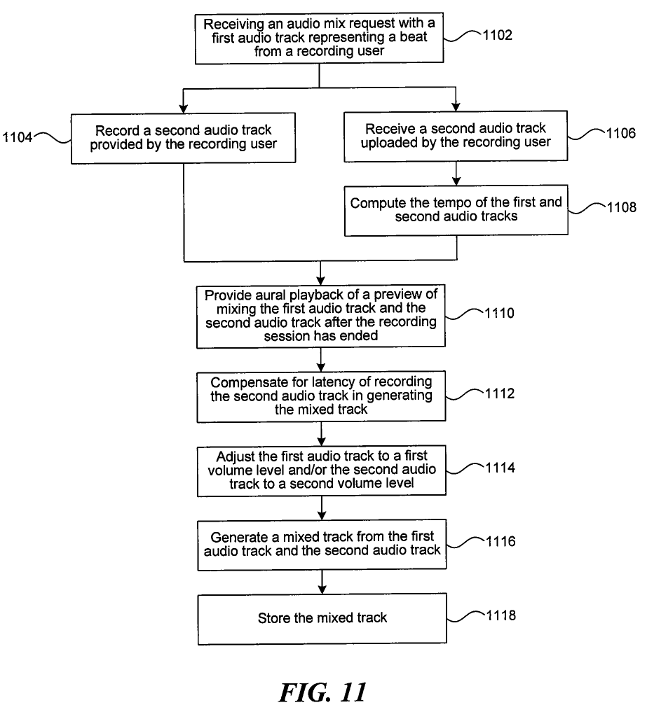

FIG. 11 depicts a flow diagram illustrating an example process of web-based musical collaboration and audio mixing, according to one embodiment.

In process 1102, an audio mix request with a first audio track representing a beat from a recording user is received. In process 1104, a second audio track provided by the recording user is recorded. Alternatively, in process 1106, a second audio track uploaded by the recording user is received and in process 1108, the tempo of the first and second audio tracks are computed.

In process 1110, aural playback of a preview of mixing the first audio track and the second audio track is provided after the recording session has ended. In process 1112, latency of recording the second audio track in generating the mixed track is compensated for. In process 1114, the first audio track is adjusted to a first volume level and/or the second audio track is adjusted to a second volume level. In process 1116, a mixed track is generated from the first audio track and the second audio track. In process 1118, the mixed track is stored.

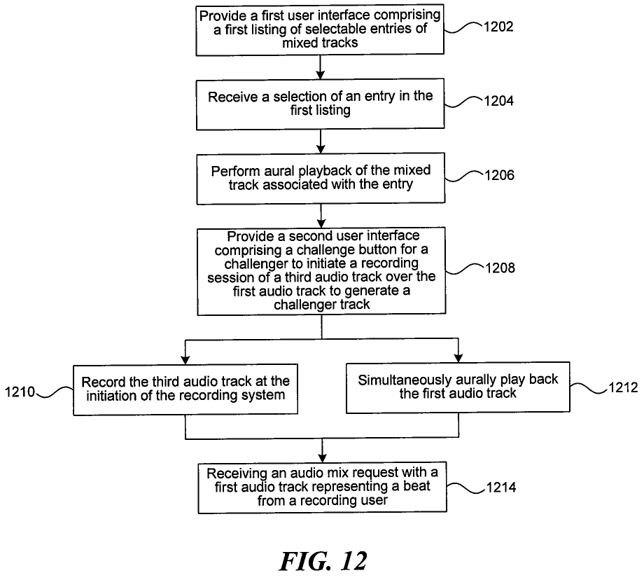

FIG. 12 depicts a flow diagram illustrating an example process of facilitating audio-based user content sharing and competition through a user interface, according to one embodiment.

In process 1202, a first user interface comprising a first listing of selectable entries of mixed tracks is provided. In process 1204, a selection of an entry in the first listing is received. In process 1206, aural playback of the mixed track associated with the entry is performed. In process 1208, a second user interface comprising a challenge button for a challenger to initiate a recording session of a third audio track over the first audio track to generate a challenger track is provided. In process 1210, the third audio track is recorded at the initiation of the recording session. In process 1212, the first audio track is simultaneously aurally played back. In process 1214, the challenger track is generated by mixing the third audio track with the first audio track.

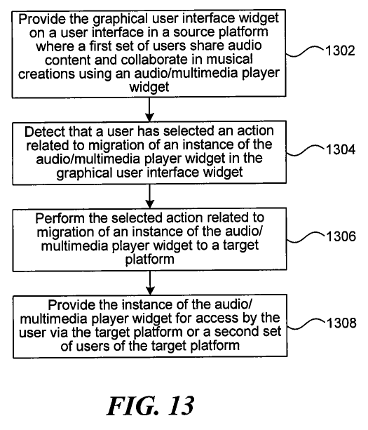

FIG. 13 depicts a flow diagram illustrating an example process of facilitating audio-based user content sharing, collaboration, and competition among multiple platforms using a graphical user interface widget, according to one embodiment.

In process 1302, the graphical user interface widget is provided on a user interface in a source platform where a first set of users share audio/video content and collaborate in eprformance creations using an audio/multimedia player widget. In process 1304, it is detected that a user has selected an action related to migration of an instance of the audio/multimedia player widget in the graphical user interface widget. In process 1306, the selected action related to migration of an instance of the audio/multimedia player widget to a target platform is performed. In process 1308, the instance of the audio/multimedia player widget is provided for access by the user via the target platform or a second set of users of the target platform.

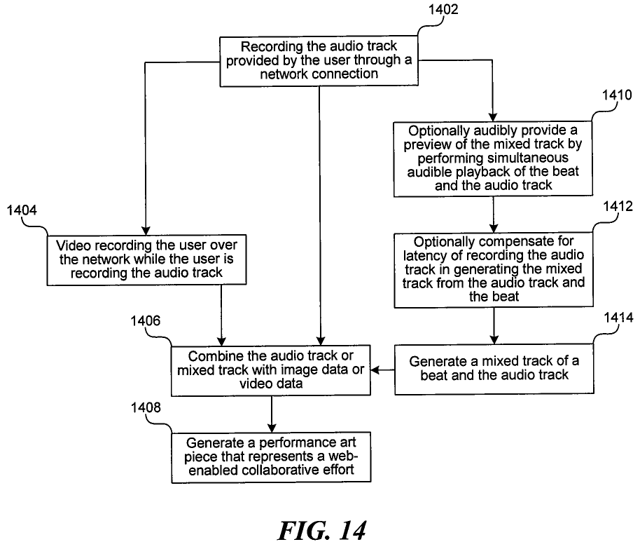

FIG. 14 depicts a flow diagram illustrating an example process of facilitating web-based multi-media collaboration and audio mixing using an online social network, according to one embodiment.

In process 1402, the audio track provided the user through a network connection is recorded. The audio track may be provided by the user of the online social network for combining with other multi-media content, including, other audio tracks, image data, text data, and/or video data. In general, the other multi-media content can be provided by the same user or other users. For example, users can upload images, audio content, and/or videos to the online social network for sharing with other users and in some instances, for generating performance art pieces that represent a web-enabled collaborative effort. Audio content can be combined with videos so as to provide animation during audio playback.

In one embodiment, the other multi-media content includes a beat with which the audio track can be mixed to generate a mixed track. In process 1410, a preview of a mixed track is optionally provided by performing simultaneous audibly playback of the beat and the audio track. In process 1412, latency of recording the audio track (e.g., due to network delays, device delays, etc.) is optionally compensated for in generating the mixed track from the audio track and the beat. In process 1414, a mixed track of a beat and the recorded audio track is generated.

In one embodiment, in addition to audio recording, the online social network can be accessed by users for recording video content in real time or near real time. The video content may be recorded using an imaging device (e.g., camera, web-cam, etc.) connected to the user device. In one embodiment, the video recording occurs when the audio recording is occurring. For example, in process 1404, the user is video recorded over the network while the user is recording the audio track.

In process 1406, the audio track or mixed track is combined with image data or video data. The image data or video data can be provided by the user or other users through uploading or recording over an Internet connection. The image data or video data may be processed (e.g., clipped, time delayed, color adjusted, etc.) to ensure synchronization with the audio content or other content the image/video is being mixed with.

In process 1408, a performance art piece that represents a web-enabled collaborative effort of multiple users is generated. The performance art piece can be generated by combining multiple pieces of multi-media content, for example, by combining video content and audio content. In one embodiment, the performance art piece if a music video.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method of web-based musical collaboration and audio mixing, comprising:
receiving an audio mix request with a first audio track representing a beat from a recording user;
recording a second audio track provided by the recording user while simultaneously performing aural playback of the beat represented by the first audio track to the recording user during a recording session;
providing aural playback of a preview of mixing the first audio track and the second audio track after the recording session has ended; and
generating a mixed track from the first audio track and the second audio track.

2. The method of claim 1, further comprising, compensating for latency of recording the second audio track in generating the mixed track from the first audio track and the second audio track.

3. The method of claim 2, wherein, the latency is compensated for by time delaying the first audio track by a predetermined amount of time when mixing with the second audio track.

4. The method of claim 3, wherein, the predetermined amount of time is within a range of 1-50 ms, 50-100 ms, or 100-500 ms.

5. The method of claim 2, further comprising, computing the latency for a particular client used by the recording user for recording the second audio track based on network delay.

6. The method of claim 1, wherein, the providing the preview comprises performing simultaneous aural playback of the first audio track and the second audio track.

7. The method of claim 1, wherein, during the preview, the first and second audio tracks are stored in memory buffer.

8. The method of claim 1, further comprising, subsequent to providing the aural playback of the preview:
adjusting one or more of, the first audio track to a first volume level and the second audio track to a second volume level;
wherein, the mixed track is generated with, one or more of, the first audio track at the first volume level and the second audio track at the second volume level.

9. The method of claim 8, wherein, the first audio track is adjusted to the first volume level responsive to a volume adjustment requested by the recording user.

10. The method of claim 1, further comprising, storing the mixed track subsequent to generating the mixed track.

11. The method of claim 1, further comprising: presenting an indication of initiation of the recording session to the recording user; wherein, the indication comprises an audible or visible indicator; and cease recording the second track responsive to a terminating indication of the recording session; the termination indication comprises one or more of, duration of elapsed time and a user-generated termination request.

12. The method of claim 1, further comprising:
receiving the audio mix request over a network connection; and
recording the first audio track or receiving an upload of the first audio track over the network connection.

13. The method of claim 1, wherein, the first audio track is user-generated content provided by the recording user or another user.

14. The method of claim 1, wherein, the preview enables the recording user to select to save or discard the second audio track.

15. The method of claim 14, further comprising, providing the recording user with an option to share the mixed track with other users.

16. The method of claim 15, further comprising, providing the recording user with privacy attribute settings for the recording user to configure access to the mixed track by other users.

17. The method of claim 16, further comprising,
presenting a visual listing of the mixed track responsive to the user selecting to share the mixed track; and
providing one or more of, a rating mechanism and a commenting mechanism of the mixed track in the visual listing.

18. A system for web-based musical collaboration and audio mixing, comprising:
a communications module to establish a communications session with a user device over a network connection; wherein, when in operation, the communications module is operable to receive user input via the user device;
a user database to store user information of a set of users;
a recording engine to record a user-provided audio track during a recording session;
a preview module to generate a preview of simultaneous aural playback of the user-provided audio track and another audio track with which the user-provided audio track is to be mixed; and
a mixing module to generate a mixed track from mixing the user-provided audio track with another audio track.

19. The system of claim 18, further comprising, a memory buffer within which the user-provided audio track is stored during the preview of the simultaneous aural playback.

20. The system of claim 18, wherein, the another audio track and the mixed track are stored in an audio repository module.

21. The system of claim 18, further comprising, a volume adjustment module to adjust relative volumes of the user-provided audio track and the another audio track to generate the mixed track.

22. The system of claim 18, further comprising, a sharing module to manage privacy attributes governing access of the mixed track by the set of users.

23. The system of claim 18, wherein, the user-provided audio track comprises user-generated content; and, wherein, the another audio track is recorded or uploaded.

24. The system of claim 18, further comprising, a timer module to track a duration of elapsed time of the recording session.

25. A method of web-based musical collaboration and audio mixing, comprising:
receiving an audio mix request with a first audio track representing a beat from a recording user;
receiving a second audio track uploaded by the recording user;
computing tempos of the first and second audio tracks;
providing aural playback of a preview of mixing the first audio track and the second audio track; and
adjusting one or more of, the first audio track to a first volume level and the second audio track to a second volume level; and
generating a mixed track from the first audio track and the second audio track based on the tempos; wherein, the mixed track is generated with, one or more of, the first audio track at the first volume level and the second audio track at the second volume level.

26. The method of claim 25, wherein, adjustment of volume levels of the first and second audio tracks are user-adjustable.

27. The method of claim 25, further comprising, storing the mixed track and sharing the mixed track with other users.

28. A method of web-based audio-content exchange and recording via a web-portal, comprising:
recording an audio track provided by a user using the web-portal over a network connection;
cease recording the audio track responsive to a termination indication;
storing the audio track responsive to the user selecting to save the audio track; and
sharing the audio track with other users via the web-portal, responsive to the user selecting to share the audio track.

29. The method of claim 29, further comprising, providing the user with a private mailbox accessible via the web-portal; wherein, the private mailbox is suitable for receipt of private messages from other users in the web-portal.

30. The method of claim 30, wherein, the private messages comprise voice-based or text-based messages; wherein, the voice-based messages are uploaded or recorded.

31. The method of claim 31, wherein, the voice-based messages comprise the audio track or the audio track recorded over a beat.

32. The method of claim 31, wherein, the voice-based messages include sound effects.

33. A method of web-based musical collaboration and audio mixing using an online social network, comprising:
generating a mixed track from mixing an audio track provided by a recording user through the online social network with another audio track;
wherein, the another audio track is provided by the recording user or another user through the online social network.

34. The method of claim 33, wherein, the audio track is audibly generated by the recording user.

35. The method of claim 33, wherein, the audio track comprises lyrics and the another audio track comprises a beat.

36. The method of claim 33, wherein, the mixed track is a rap song.

37. A system for web-based musical collaboration and audio mixing using an online social network, comprising:
means for, generating a mixed track from mixing an audio track provided by a recording user through the online social network with another audio track;
wherein, the another audio track is provided by the recording user or another user while accessing the online social network.

38. A method of web-based multi-media collaboration and audio mixing using an online social network, comprising:
generating a performance art piece representing web-enabled collaborative effort, the performance art piece generated by combining a plurality of multi-media content;
the plurality of multi-media content comprising an audio track provided through a network connection; the audio track being provided by a user of the online social network for combining with a sub-plurality of the plurality of multi-media content;
wherein, the sub-plurality of the plurality of multi-media content is provided by the user or other users.

39. The method of claim 38, wherein, the sub-plurality of the plurality of multi-media content comprises another audio track of a beat with which the audio track is mixed.

40. The method of claim 39, further comprising, generating a mixed track of the beat and the audio track.

41. The method of claim 40, further comprising, audibly providing a preview of the mixed track by performing simultaneous audible playback of the beat and the audio track.

42. The method of claim 40, further comprising, compensating for latency of recording the audio track in generating the mixed track from the audio track and the beat.

43. The method of claim 38, wherein, the plurality of multi-media content comprises image data or video data provided by the user or other users.

44. The method of claim 43, further comprising, combining the audio track with the image data or the video data to generate the performance art piece.

45. The method of claim 44, wherein, the performance art piece is a music video.

46. The method of claim 44, wherein, the audio track is audibly generated by the user and the video is generated from a video recording of the user over the network while the user is recording the audio track.
